(19) United States
(12) Patent Application Publication
(10) Pub. No.: US 2023/0148372 A1
(43) Pub. Date: May 11, 2023

(54) Degradable, Printable Poly(Propylene Fumarate)-Based ABA Triblock Elastomers

(71) Applicants: Matthew BECKER, Durham, NC (US); Shannon PETERSEN, Durham, NC (US)

(72) Inventors: Matthew BECKER, Durham, NC (US); Shannon PETERSEN, Durham, NC (US)

(73) Assignee: Duke University, Durham, NC (US)

(21) Appl. No.: 17/976,584

(22) Filed: Oct. 28, 2022

Related U.S. Application Data
(60) Provisional application No. 63/272,843, filed on Oct. 28, 2021.

(51) Int. Cl. C08G 63/60; C08G 63/83; C09D 167/06; C08G 81/00; C08J 3/24; B33Y 70/00

(52) U.S. Cl. CPC C08G 63/60; C08G 63/83; C09D 167/06; C08G 81/00; C08J 3/24; B33Y 70/00; C08J 2367/02

(57) ABSTRACT

In various embodiments, the present invention is directed to ABA triblock copolymers having crosslinkable poly(propylene fumarate A blocks and a more flexible poly(lactone) B block formed by sequential ring-opening polymerization and ring-opening copolymerization. These ABA triblock polymers made using ring-opening polymerization of one or more lactone monomers using a bifunctional initiator to form a poly(lactone) B block having terminal hydroxyl groups and the ring-opening copolymerization of maleic anhydride and propylene oxide followed by isomerization of the maleate double bond using an organic base to form the poly(propylene fumarate)(PPF) A blocks. When crosslinked photochemically using, for example, a continuous liquid interface production digital light processing (DLP) Carbon M2 printer, these ABA type triblock copolymers form durable elastomers with tunable degradation and elastic properties. In various embodiments, these polymers are shown to undergo slow, hydrolytic degradation in vitro with minimal loss of mechanical performance during degradation.

### CROSS REFERENCE TO RELATED APPLICATIONS

This application claims the benefit of U.S. provisional patent application Ser. No. 63/272843 entitled “Degradable, Printable Poly(Propylene Fumarate)-Based ABA Triblock Elastomers and Methods of Making and Using Same,” filed Oct. 28, 2021, and incorporated herein by reference in its entirety.

### FIELD OF THE INVENTION

One or more embodiments of the present invention relates to degradable ABA triblock copolymers. In certain embodiments, the present invention is directed to facile synthesis of stereolithographically printable elastomers using degradable polyesters.

### BACKGROUND OF THE INVENTION

Additive manufacturing has proven to be a disruptive technology in medicine and healthcare, finding applications in models, implants, prosthetics, and pharmaceuticals. In particular, the fields of tissue engineering and regenerative medicine have benefitted from the flexibility and precision of three-dimensional (3D) printing technologies.3,4 Although regenerative medicine is still in its infancy with regards to scope and clinical translation, 3D printing offers the ability and economic incentive to address complicated defects that have proven challenging to treat with conventional surgical techniques.

Several types of 3D printers have been used for the fabrication of biological scaffolds, including extrusion, ink-jetting, and stereolithography (SLA). SLA is a printing technique that typically uses ultraviolet (UV) light to photochemically crosslink a liquid polymer resin in a layer-by-layer fashion to build a 3D object. Recent advances in printing technology such as continuous digital light processing (cDLP) have improved upon build speeds and mechanical uniformity of SLA printed scaffolds. Continuous liquid interface production (CLIP) utilizes a bottom-up fabrication approach with an oxygen permeable membrane to generate a small-dead zone above the resin tray. This dead zone removes the need for each layer to be delaminated mechanically from the resin tray, which reduces print times and defects in the 3D-structure.

While the potential applications for SLA are numerous, constraints from printing technology and biological restrictions for implantable materials make material design particularly challenging. Well-known degradable polyesters such as poly(ε-caprolactone) (PCL), poly-L-lactide (PLLA), and poly(propylene fumarate) (PPF) have been utilized widely. While these polymers have each been used in bone, cartilage, and other hard tissues applications, they lack the elasticity found in many soft tissues, and the mechanical mismatch often leads to device failure. Contrarily, hydrogel inks and bioinks formulated from naturally occurring polymers that have been synthetically modified for printability, such as collagen, alginate, gelatin, and hyaluronic acid, and the synthetic polymer polyethylene glycol (PEG), have also been investigated with favorable biological responses and pre-clinical outcomes. However, these materials often lack the mechanical strength and durability to bear loads in structural or dynamic tissues. In order to address these limitations, printable materials that form elastomeric structures are needed, though few examples currently exist.

PPF is degradable polyester containing unsaturated alkenes as reactive handles for photochemical crosslinking. It has been investigated widely in tissue engineering applications. These studies have shown low cytotoxicity, hydrolytic degradation into resorbable byproducts over time, and comparable mechanical properties to human trabecular bone. PPF was first synthesized in 1994 using a step-growth polymerization of propylene glycol and fumaric acid. Later studies of PPF synthesis using metal-based catalysts in a ring-opening copolymerization (ROCOP) of maleic anhydride (MAn) and propylene oxide (PO) significantly enhances yields and control over molecular mass and molecular mass distribution. More recently the optimization of a Mg(BHT)₂(THF)₂ catalyst eliminated the use of toxic transition metals and allows for functional handles at the chain end for post-printing modification. The catalyst was further used to combine the ring-opening polymerization (ROP) of lactones with the ROCOP of epoxides and anhydrides to yield PPF diblock copolymers in a one-pot, sequential polymerization method. (See, Petersen, S. R.; Wilson, J. A.; Becker, M. L., Versatile Ring-Opening Copolymerization and Post-printing Functionalization of Lactone and Poly(propylene fumarate) Block Copolymers: Resorbable Building Blocks for Additive Manufacturing. Macromolecules 2018, 51 (16), 6202-6208, the disclosure of which is incorporated herein by reference in its entirety.) This synthesis allowed for copolymerization with a large library of lactones including γ-methyl-ε-caprolactone (γmεCL), which has recently been polymerized and used as a component in several degradable elastomer systems. (See, e.g., De Hoe, G.; Zumstein, M. T.; Tiegs, B. J.; Brutman, J. P.; McNeill, K.; Sander, M.; Coates, G. W.; Hillmyer, M. A., Sustainable Polyester Elastomers from Lactones: Synthesis, Properties, and Enzymatic Hydrolyzability. J. Am. Chem. Soc. 2018, 140 (3), 963-973; Xiao, Y.; Lang, S.; Zhou, M.; Qin, J.; Yin, R.; Gao, J.; Heise, A.; Land, M., A highly stretchable bioelastomer prepared by UV curing of liquid-like poly(4-methyl-ε-caprolactone) precursors. J Mater Chem B 2017, 5 (3), 595-603; and Watts, A.; Kurokawa, N.; Hillmyer, M. A., Strong, Resilient, and Sustainable Aliphatic Polyester Thermoplastic Elastomers. Biomacromolecules 2017, 18 (6), 1845-1845, the disclosures of which are incorporated herein by reference in their entirety).

The synthesis of degradable polyesters using the ROP of lactones and the ROCOP of epoxides with cyclic anhydrides have both been investigated individually and a wide variety of material properties are accessible using these monomer feedstocks. (See, e.g., DiCiccio, A. M.; Coates, G. W., Ring-Opening Copolymerization of Maleic Anhydride with Epoxides: A Chain-Growth Approach to Unsaturated Polyesters. J. Am. Chem. Soc. 2011, 133, 10724-10727; Wilson, J. A.; Hopkins, S. A.; Wright, P. M.; Dove, A. P., Dependence of Copolymer Sequencing Based on Lactone Ring Size and ε-Substitution. ACS Macro Lett. 2016, 5 (3), 346-350; Longo, J. M.; Sanford, M. J.; Coates, G. W., Ring-Opening Copolymerization of Epoxides and Cyclic Anhydrides with Discrete Metal Complexes: Structure-Property Relationships. Chem. Rev. 2016, 116, 15167-15197; Paul, S.; Zhu, Y.; Romain, C.; Brooks, R.; Saini, P. K.; Williams; K, C., Ring-opening copolymerization (ROCOP): synthesis and properties of polyesters and polycarbonates. Chem. Commun. 2015, 51, 6459-6479; and Zhang, D.; Hillmyer, M. A.; Tolman, W. B., Catalytic Polymerization of a Cyclic Ester Derived from a “Cool” Natural Precursor. Biomacromolecules 2005, 6, 2091-2095, the disclosures of which are incorporated herein by reference in their entirety).

The combination of three distinct monomer families has been shown to expand the range of accessible properties, and recent efforts have highlighted progress in combining these distinct polymerization cycles in single catalyst, one-pot systems. (See, Longo, J. M.; Sanford, M. J.; Coates, G. W., Ring-Opening Copolymerization of Epoxides and Cyclic Anhydrides with Discrete Metal Complexes: Structure-Property Relationships. Chem. Rev. 2016, 116, 15167-15197; Colquhoun, H.; Lutz, J. F., Information-containing macromolecules. Nat. Chem. 2014, 6, 455-456; Lutz, J. F.; Ouchi, M.; Liu, D. R.; Sawamoto, M., Sequencecontrolled polymer. Science 2013, 341, 1238149; Jeske, R. C.; Rowley, J. M.; Coates, G. W., Pre-rate-determining Selectivity in the Terpolymerization of Epoxides, Cyclic Anhydrides, and CO2: a One-step Route to Diblock Copolymers. Angew. Chem. Int. Ed. 2008, 47, 6041-6044; Huijser, S.; Hosseini Nejad, E.; Sablong, R. I.; de Jong, C.; Koning, C. E.; Duchateau, R., Ring-Opening Co- and Terpolymerization of an Alicyclic Oxirane with Carboxylic Acid Anhydrides and CO₂ in the Presence of Chromium Porphyrinato and Salen Catalysts. Macromolecules 2011, 44, 1132-1139; Darensbourg, D. J.; Poland, R. R.; Escobedo, C., Kinetic Studies of the Alternating Copolymerization of Cyclic Acid Anhydrides and Epoxides, and the Terpolymerization of Cyclic Acid Anhydrides, Epoxides, and CO2 Catalyzed by (salen)Cr¹¹¹C. Macromolecules 2012, 45, 2242-2248; Saini, P. K.; Romain, C.; Zhu, Y.; Williams, C. K., Dimagnesium and zinc catalysts for the copolymerization of phthalic anhydride and cyclohexene oxide. Polym. Chem. 2014, 5, 6068-6075; Olsen, P.; Odelius, K.; Keul, H.; Albertsson, A. C., Macromolecular Design via an Organocatalytic, Monomer-Specific and Temperature-Dependent “On/Off Switch”. High Precision Synthesis of Polyester/Polycarbonate Multiblock Copolymers. 2015 2015, 48, 1703-1710; Kramer, J. W.; Treitler, D. S.; Dunn, E. W.; Castro, P. M.; Roisnel, T.; Thomas, C. M.; Coates, G. W., Polymerization of Enantiopure Monomers Using Syndiospecific Catalysts: A New Approach To Sequence Control in Polymer Synthesis. J. Am. Chem. Soc. 2009, 131, 16042-16044; and Jaffredo, C. G.; Chapurina, Y.; Guillaume, S. M.; Carpentier, J. F., From syndiotactic homopolymers to chemically tunable alternating copolymers: highly active yttrium complexes for stereoselective ringopening polymerization of β-malolactonates. Angew. Chem. Int. Ed. 2014, 53, 2687-2691, the disclosures of which are incorporated herein by reference in their entirety).

Additive manufacturing is rapidly advancing tissue engineering, but the scope of its clinical translation is limited by a lack of materials designed to meet specific mechanical properties and resorption timelines. What is needed in the art are materials that are printable via photochemical crosslinking, fully degradable, and elastomeric.

### SUMMARY OF THE INVENTION

In various embodiments, the present invention is directed to ABA triblock copolymers having crosslinkable poly(propylene fumarate A blocks and a more flexible poly(lactone) B block formed by sequential ring-opening polymerization and ring-opening copolymerization. These ABA triblock polymers made using ring-opening polymerization of one or more lactone monomers using a bifunctional initiator to form a poly(lactone) B block having terminal hydroxyl groups and the ring-opening copolymerization of maleic anhydride and propylene oxide followed by isomerization of the maleate double bond using an organic base to form the poly(propylene fumarate)(PPF) A blocks. In one or more embodiments, the present invention provides a series of poly(propylene fumarate-b-γ-methyl-ε-caprolactone-b-propylene fumarate) ABA triblock polymers made using a sequential ring-opening polymerization of γ-methyl-ε-caprolactone using a bifunctional initiator and ring-opening copolymerization of maleic anhydride and propylene oxide followed by isomerization of the maleate double bond using an organic base to form the poly(propylene fumarate) A blocks. When crosslinked photochemically using a continuous liquid interface production digital light processing (DLP) Carbon M2 printer, these ABA type triblock copolymers form durable elastomers with tunable degradation and elastic properties. (See, FIG. 1) In various embodiments, these polymers are shown to undergo slow, hydrolytic degradation in vitro with minimal loss of mechanical performance during degradation.

In a first aspect, the present invention is directed to an ABA triblock copolymer comprising: a first and second A polymer block comprising poly(propylene fumarate); and a B polymer block comprising two poly(lactone) chains extending outward from the residue of a divalent initiator, wherein the first and second A polymer blocks are each bonded covalently to an end of the B polymer block to form an ABA block copolymer. In some embodiments, the poly(lactone) chains will comprise residues of two or more lactone monomers selected from the group consisting of α-chloro-ε-caprolactone, 4-chloro-ε-caprolactone, 4-methyl-7-isopropyl-ε-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-decalactone macrolactones, ω-pentadecalactone (PDL), functional lactones, 6-propargyl-ε-nonalactone (θρεNL), α-propargyl-ε-caprolactone (αρεCL), and combinations thereof. In one or more embodiments, the ABA triblock copolymer of the present invention includes any one or more of the above referenced embodiments of the first aspect of the present invention wherein the B polymer block comprises γ-methyl-ε-caprolactone.

In one or more embodiments, the ABA triblock copolymer of the present invention includes any one or more of the above referenced embodiments of the first aspect of the present invention wherein the divalent initiator is selected from the group consisting of fumaric acid (FmA), succinic acid, 1,4-cyclohexanedicarboxylic acid (CHDA), 1,4-dimethoxy cyclohexane (CHDM), 1,4-dimethoxy benzene (BDM), cis-but-2-ene-1,4-diol ((Z)-but-2-ene-1,4-diol) (cBD), but-2-yne-1,4-diol (BYD), 1,4-butanediol, 1,5-pentanediol, 1,6-hexanediol (HDO), 1,8-octanediol, 1,10-decanediol (DD), 1,12-dodecandiol, and combinations thereof.

In one or more embodiments, the ABA triblock copolymer of the present invention includes any one or more of the above referenced embodiments of the first aspect of the present invention having the formula:

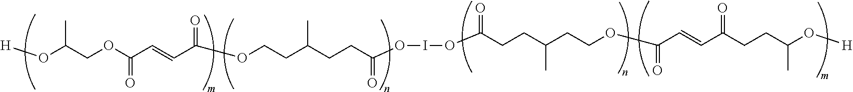

where each n is an integer from about 5 to about 25, each m is an integer from about 5 to about 30, and I is the residue of the divalent initiator.

In some embodiments, the ABA triblock copolymer of the present invention includes any one or more of the above referenced embodiments of the first aspect of the present invention having the formula:

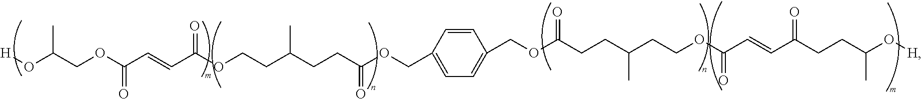

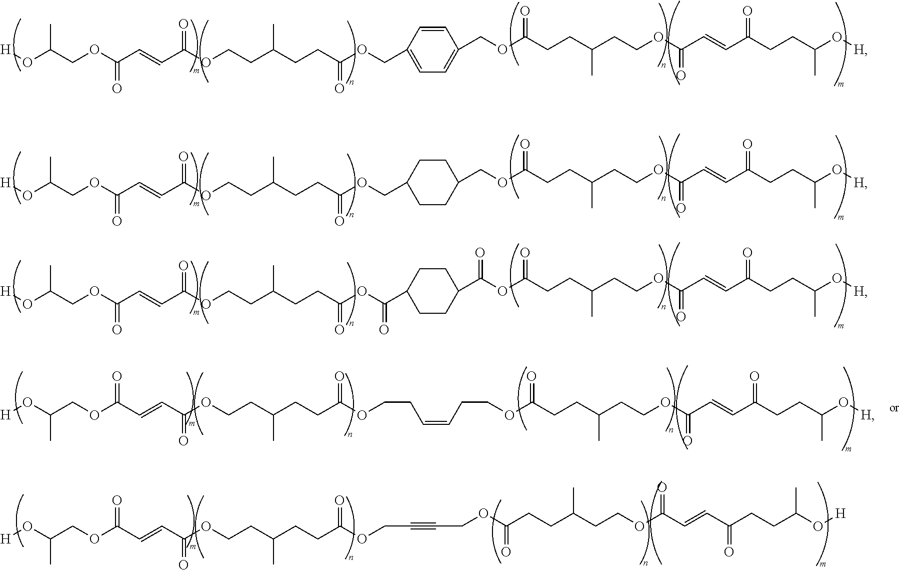

where each n is an integer from about 5 to about 25 and each m is an integer from about 5 to about 30. In some embodiments, the ABA triblock copolymer of the present invention includes any one or more of the above referenced embodiments of the first aspect of the present invention having the formula:

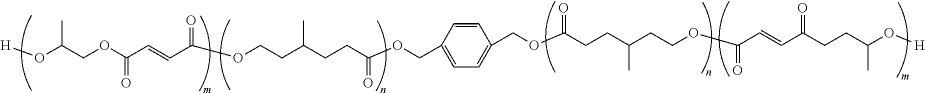

where each n is an integer from about 5 to about 25 and each m is an integer from about 5 to about 30.

In one or more other embodiments, the ABA triblock copolymer of the present invention includes any one or more of the above referenced embodiments of the first aspect of the present invention having the formula:

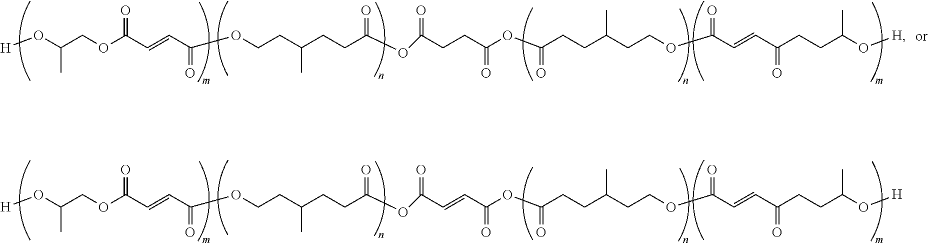

where each n is an integer from about 5 to about 25 and each m is an integer from about 5 to about 30.

In some other embodiments, the ABA triblock copolymer of the present invention includes any one or more of the above referenced embodiments of the first aspect of the present invention having the formula:

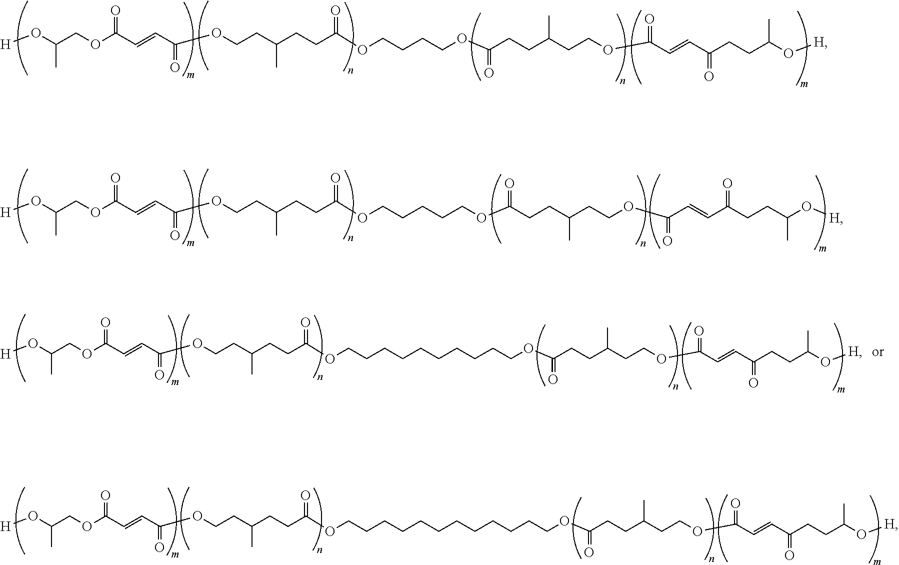

where each n is an integer from about 5 to about 25 and each m is an integer from about 5 to about 30.

In one or more embodiments, the ABA triblock copolymer of the present invention includes any one or more of the above referenced embodiments of the first aspect of the present invention wherein the B polymer block has a total degree of polymerization of from about 5 to about 50, preferably from about 5 to about 20, and more preferably from about 5 to about 10. In one or more embodiments, the ABA triblock copolymer of the present invention includes any one or more of the above referenced embodiments of the first aspect of the present invention wherein the A polymer block has a degree of polymerization of from about 5 to about 30, preferably from about 5 to about 20, and more preferably from about 5 to about 10.

In various embodiments, the ABA triblock copolymer of the present invention includes any one or more of the above referenced embodiments of the first aspect of the present invention wherein the ratio of the degree of polymerization (DPₙ) of the first A polymer block to the total DPₙ the B polymer block to the DPₙ of the second A polymer block is from 5:10:5 to 5:50:5, preferably from about 5:10:5 to 5:30:5, and more preferably from about 5:10:5 to 5:20:5. In one or more embodiments, the ABA triblock copolymer of the present invention includes any one or more of the above referenced embodiments of the first aspect of the present invention wherein the ratio of the degree of polymerization (DPₙ) of the first A polymer block to the total (DPₙ) of the B polymer block to the (DPₙ) of the second A polymer block is about 5:10:5 or about 5:20:5. In some embodiments, the ABA triblock copolymer of the present invention includes any one or more of the above referenced embodiments of the first aspect of the present invention having from about 1 mol % to about 50 mol % fumarate units.

In one or more embodiments, the ABA triblock copolymer of the present invention includes any one or more of the above referenced embodiments of the first aspect of the present invention a complex viscosity of from about 0.1 Pa·s to about 15 Pa·s, preferably from about 1 Pa·s to about 10 Pa·s, and more preferably from about 3 Pa·s to about 7 Pa·s. In some embodiments, the ABA triblock copolymer of the present invention includes any one or more of the above referenced embodiments of the first aspect of the present invention having a zero-sheer viscosity of from about 1 Pa·s to about 400 Pa·s, preferably from about 1 Pa·s to about 100 Pa·s, and more preferably from about 1 Pa·s to about 20 Pa·s.

In one or more embodiments, the ABA triblock copolymer of the present invention includes any one or more of the above referenced embodiments of the first aspect of the present invention wherein the ABA triblock copolymer is degradable within the body of a patient.

In a second aspect, the present invention is directed to a method for making an ABA triblock copolymer comprising: reacting a lactone monomer, a divalent initiator having at least two reactive hydroxyl or carboxylic acid groups, and a catalyst to form a poly(lactone) B block polymer segment having a first and second end, the first and second ends having a reactive hydroxyl or carboxyl group; reacting the poly(lactone) B block polymer segment with maleic anhydride, propylene oxide, and a catalyst to form a first poly(propylene maleate) polymer A block covalently bonded to and extending outward from the first end of the poly(lactone) B block polymer segment and a second poly(propylene maleate) polymer A block covalently bonded to and extending outward from the second end of the poly(lactone) B block polymer segment to form an ABA triblock copolymer intermediate having two poly(propylene maleate) A blocks and a poly(lactone) B block; and isomerizing the ABA triblock copolymer intermediate to form an ABA triblock copolymer having two crosslinkable poly(propylene fumarate) A blocks and a poly(lactone) B block.

In some embodiments, the method for making an ABA triblock copolymer of the present invention includes any one or more of the above referenced embodiments of the second aspect of the present invention wherein the lactone monomer is selected from the group consisting of selected from the group consisting of α-chloro-ε-caprolactone, 4-chloro-ε-caprolactone, 4-methyl-7-isopropyl-ε-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-decalactone macrolactones, ω-pentadecalactone (PDL), functional lactones, 6-propargyl-ε-nonalactone (θρϑNL), α-propargyl-ε-caprolactone (αρεCL), and combinations thereof. In some of these embodiments, the method for making an ABA triblock copolymer of the present invention includes any one or more of the above referenced embodiments of the second aspect of the present invention wherein the lactone monomer is γ-methyl-ε-caprolactone.

In some embodiments, the method for making an ABA triblock copolymer of the present invention includes any one or more of the above referenced embodiments of the second aspect of the present invention wherein the divalent initiator has two reactive hydroxyl or carboxylic acid groups. In one or more embodiments, the method for making an ABA triblock copolymer of the present invention includes any one or more of the above referenced embodiments of the second aspect of the present invention wherein the divalent initiator is selected from the group consisting of fumaric acid (FmA), succinic acid, 1,4-cyclohexanedicarboxylic acid (CHDA), 1,4-methoxy cyclohexane (CHDM), 1,4-methoxy benzene (BDM), cis-but-2-ene-1,4-diol ((Z)-but-2-ene-1,4-diol) (cBD), but-2-yne-1,4-diol (BYD), 1,4-butanediol, 1,5-pentanediol, 1,6-hexanediol (HDO), 1,8-octanediol, 1,10-decanediol (DD), 1,12-dodecandiol, and combinations thereof. In one or more embodiments, the method for making an ABA triblock copolymer of the present invention includes any one or more of the above referenced embodiments of the second aspect of the present invention wherein the catalyst is Mg(BHT)₂(THF)₂.

In some embodiments, the method for making an ABA triblock copolymer of the present invention includes any one or more of the above referenced embodiments of the second aspect of the present invention wherein the poly(lactone) B block polymer segment has a total degree of polymerization (DPₙ) of from about 5 to about 50. In one or more embodiments, the method for making an ABA triblock copolymer of the present invention includes any one or more of the above referenced embodiments of the second aspect of the present invention wherein the each one of the first and second poly(propylene maleate) polymer A blocks have a degree of polymerization (DPₙ) of from about 5 to about 30. In some embodiments, the method for making an ABA triblock copolymer of the present invention includes any one or more of the above referenced embodiments of the second aspect of the present invention wherein the ratio of the degree of polymerization (DPₙ) of the first poly(propylene maleate) polymer A block to the total DPₙ of the poly(lactone) B block polymer segment to the DPₙ of the second poly(propylene maleate) polymer A block is from 5:10:5 to 5:50:5, preferably from about 5:10:5 to 5:30:5, and more preferably from about 5:10:5 to 5:20:5.

In one or more embodiments, the method for making an ABA triblock copolymer of the present invention includes any one or more of the above referenced embodiments of the second aspect of the present invention wherein the ABA block copolymer intermediate is a poly(propylene maleate-b-γ-methyl-ε-caprolactone-b-propylene maleate) ABA block copolymer intermediate having the formula:

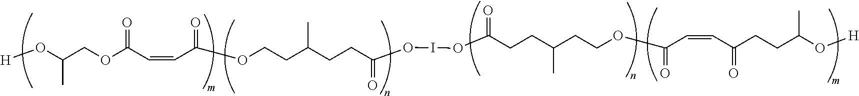

where each n is an integer from about 5 to about 25, each m is an integer from about 5 to about 30, and I is the residue of the divalent initiator. In some embodiments, the method for making an ABA triblock copolymer of the present invention includes any one or more of the above referenced embodiments of the second aspect of the present invention wherein the ABA block copolymer is a poly(propylene fumarate-b-γ-methyl-ε-caprolactone-b-propylene fumarate) ABA block copolymer having the formula:

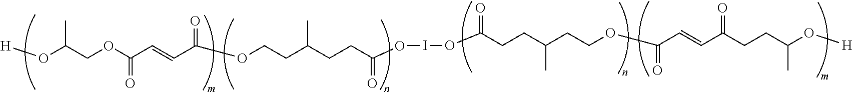

where each n is an integer from about 5 to about 25, each m is an integer from about 5 to about 30, and I is the residue of the divalent.

In a third aspect, the present invention is directed to a 3D printable polymer resin comprising the ABA triblock copolymer described above. In one or more embodiments, the 3D printable polymer resin of the present invention includes any one or more of the above referenced embodiments of the third aspect of the present invention comprising a poly(propylene fumarate-b-γ-methyl-ε-caprolactone-b-propylene fumarate) ABA triblock copolymer.

In one or more embodiments, the 3D printable polymer resin of the present invention includes any one or more of the above referenced embodiments of the third aspect of the present invention further comprising: an organic solvent selected from the group consisting of ethyl acetate, THF, acetone, DMSO, chloroform, methanol, ethanol, diethyl fumarate and combinations thereof; and a photoinitiator. In some embodiments, the 3D printable polymer resin of the present invention includes any one or more of the above referenced embodiments of the third aspect of the present invention comprising from about 1 wt. % to about 60 wt. % diethyl fumarate.

In various embodiments, the 3D printable polymer resin of the present invention includes any one or more of the above referenced embodiments of the third aspect of the present invention having a complex viscosity of from about 0.1 Pas to about 15 Pa·s, preferably from about 1 Pa·s to about 10 Pa·s, and more preferably from about 3 Pa·s to about 7 Pa·s. In one or more embodiments, the 3D printable polymer resin of the present invention includes any one or more of the above referenced embodiments of the third aspect of the present invention having a zero-sheer viscosity of from 1 Pa·s to about 100 Pa·s, preferably from about 1 Pa·s to about 20 Pa·s, and more preferably from about 1 Pa·s to about 10 Pa·s.

In a fourth aspect, the present invention is directed to a photolithographically-printable elastomer comprising one or more of the ABA triblock copolymers described above.

In a fifth aspect, the present invention is directed to a 3D printed polymer structure comprising a covalently crosslinked elastic network formed by photochemically crosslinking the 3D printable polymer resins described above.

In a sixth aspect, the present invention is directed to a 3D printed polymer structure comprising the 3D printable polymer resins described above.

In one or more embodiments, the 3D printable polymer structure of the present invention includes any one or more of the above referenced embodiments of the fourth, fifth and/or sixth aspects of the present invention wherein the 3D printed polymer structure has a strain at break (ε_{break}) of from about from about 150% to about 250%, preferably from about 150% to about 200%, and more preferably from about 150% to about 170%. In one or more embodiments, the 3D printable polymer structure of the present invention includes any one or more of the above referenced embodiments of the fourth, fifth and/or sixth aspects of the present invention wherein the 3D printed polymer structure has a Young's modulus (E₀) of from about 1.6 MPa to about 12.6 MPa, preferably from about 5 MPa to about 12.6 MPa, and more preferably from about 8 MPa to about 12.6 MPa. In one or more embodiments, the 3D printable polymer structure of the present invention includes any one or more of the above referenced embodiments of the fourth, fifth and/or sixth aspects of the present invention wherein the 3D printed polymer structure has a stress at break (UTS) of from about 0.33 MPa to about 1.27 MPa, preferably from about 0.5 MPa to about 1.27 MPa, and more preferably from about 1.00 MPa to about 1.27 MPa.

### BRIEF DESCRIPTION OF THE DRAWINGS

For a more complete understanding of the features and advantages of the present invention, reference is now made to the detailed description of the invention along with the accompanying figures in which:

FIG. 1 is a schematic representation showing the elastomer structure of 3D printed structures made using the ABA triblock copolymers of the present invention.

FIG. 2 is a comparison of the ¹H NMR spectra of poly(PF-b-γmεCL-b-PF) triblock copolymers with targeted block ratios [5]:[16]:[5] (top), [5]:[30]:[5] (middle), and [5]:[50]:[5] (bottom) (500 MHz, CDCI₃, 303 K).

FIGS. 3 are DSC thermograms for the second heating/cooling cycle of poly(PF-b-γmεCL-b-PF) triblock copolymers with targeted block ratios [5]:[16]:[5], [5][30]:[5], and [5]:[50]:[5] at a rate of 10° C./min.

FIG. 4 is a second cycle DSC thermogram of [5:16:5] PF:γmεCL:PF.

FIG. 5 is a second cycle DSC thermogram of [5:30:5] PF:γmεCL:PF.

FIG. 6 is a second cycle DSC thermogram of [5:50:5] PF:γmεCL:PF.

FIG. 8 is a graph showing zero-shear viscosity of poly(PF-b-γmεCL-b-PF) triblock copolymers a function of Mₙ with varied PPF:DEF ratios.

FIG. 7 is a graph showing complex viscosity of poly(PF-b-γmεCL-b-PF) triblock copolymers with targeted block ratios [5]:[16]:[5], [5]:[30]:[5], and [5]:[50]:[5] with varied PPF:DEF dilutions.

FIGS. 9 are SEC chromatograms of poly(PF-b-γmεCL-b-PF) triblock copolymers with targeted block ratios of [5]:[16]:[5], [5]:[30]:[5], and [5]:[50]:[5] determined using SEC in CHCl₃ against polystyrene standards.

FIG. 10 is a graph showing stress vs. strain data obtained by uniaxial extension until failure of 3D printed poly(PF-b-γmεC-b-PF) tensile bars with a [5]:[16]:[5] block ratio as a function of post-cure duration (500 mm/min rate of extension).

FIG. 11 is a comparison of FTIR spectra of the resin, newly printed (“green”) polymer, and at 54 min, 72 min, 108 min, and 144 min post cured polymers (in H₂O) showing a reduction of the C═C stretching (1625-1665 cm⁻¹) region over time as the polymer is further crosslinked post-printing.

FIG. 12 is a plot of stress vs. time of a 3D printed poly(PF-b-γmεCL-b-PF) tensile bars with a [5]:[16]:[5] block ratio undergoing cyclic deformation to 20% its average strain at break for ten repeated cycles (10 mm/min rate of extension).

FIG. 13 is a comparison of hysteresis curves of a 3D printed poly(PF-b-γmεC-b-PF) tensile bar with a [5]:[16]:[5] block ratio on its first deformation cycle and tenth deformation cycle (10 mm/min rate of extension).

FIGS. 14A-B are graphs showing degradation properties various embodiments of the of the ABA triblock copolymers of the present invention at 37° C. and 50° C. FIG. 14A is a graph showing the degradation of 3D printed poly(PF-b-γmεCL-b-PF) discs (0.6 mm thickness, 12.5 mm diameter) with a [5]:[16]:[5] block ratio at 37° C. in PBS buffer solution (original pH=7.4) while shaking. The plot tracks the mass increase of the swollen discs, the mass loss of the dried discs, and the pH change of the PBS buffer solution as a function of degradation time. FIG. 14B is a graph showing the degradation of 3D printed poly(PF-b-γmεCL-b-PF) discs (0.6 mm thickness, 12.5 mm diameter) with a [5]:[16]:[5] block ratio at 50° C. in PBS buffer solution (original pH=7.4). The plot tracks the mass increase of the swollen discs, the mass loss of the dried discs, and the pH change of the PBS buffer solution as a function of degradation time.

FIGS. 15A-Bare graphs showing mechanical properties over time of various embodiments of the of the ABA triblock copolymers of the present invention during degradation. FIG. 15A is a graph showing a mechanical characterization of 3D printed poly(PF-b-γmεCL-b-PF) tensile bars (0.6 mm thickness) with a [5]:[16]:[5] block ratio being degraded at 37° C. in PBS buffer solution (original pH=7.4) while shaking. The plot tracks the Young's modulus (MPa), stress at break (MPa), and elongation at break (%) as a function of degradation time. FIG. 15B is a graph showing swelling of 3D printed poly(PF-b-γmεCL-b-PF) tensile bars (0.6 mm thickness) with a [5]:[16]:[5] block ratio at 37° C. in PBS buffer solution (original pH=7.4) over time while shaking. The plot tracks the mass increase of the swollen tensile bars and the pH change of the PBS buffer solution as a function of degradation time.

FIG. 16 is an image showing a collection of the 3D printed structures made using the ABA triblock copolymers of the present invention including the discs and tensile bars used for the degradation and mechanical testing.

FIG. 17 is a stress strain curve showing cyclic testing of [5]:[16]:[5] PF:γmεCL:PF between 3% strain and 34% strain (20% the average strain at break) for ten continuous cycles.

The patent or application file contains at least one drawing executed in color. Copies of this patent or patent application publication with color drawing(s) will be provided by the Office upon request and payment of the necessary fee.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

In various embodiments, the present invention relates to stereolithographically printable copolymers comprising well-known degradable polyesters, elastomers prepared therefrom, and facile methods for their synthesis. More specifically, the present invention is directed to ABA triblock copolymers having two crosslinkable poly(propylene fumarate) A blocks and a more flexible poly(lactone) B block formed by sequential ring-opening polymerization and ring-opening copolymerization. These ABA triblock polymers made b first using ring-opening polymerization of one or more lactone monomers using Mg(BHT)₂(THF)₂ catalyst and a bifunctional initiator to form a flexible non-crystalline poly(lactone) B block and then ring-opening copolymerization of maleic anhydride and propylene oxide from the terminal hydroxyl groups of the B polymer block (again using Mg(BHT)₂(THF)₂ catalyst) to form poly(propylene maleate) A block intermediates, followed by isomerization of the maleate double bonds using an organic base to form the poly(propylene fumarate)(PPF) A blocks. When crosslinked photochemically using, for example, a continuous liquid interface production digital light processing (DLP) Carbon M2 printer, these ABA type triblock copolymers form durable elastomers with tunable degradation and elastic properties. In various embodiments, these polymers are shown to undergo slow, hydrolytic degradation in vitro with minimal loss of mechanical performance during degradation.

The following terms may have meanings ascribed to them below, unless specified otherwise. However, it should be understood that other meanings that are known or understood by those having ordinary skill in the art are also possible, and within the scope of the present disclosure.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).Further, as used herein, the transitional phrase “consisting essentially of” (and grammatically appropriate variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

The articles “a” and “an” are used herein to refer to one or to more than one (i.e. at least one) of the grammatical object of the article. By way of example, “an element” means at least one element and can include more than one element. Similarly, the terms “a,” “an” or “the” before an element or feature does not exclude the presence of a plurality of these elements or features, unless the context clearly dictates otherwise.

The term “about” is used herein to provide flexibility to a numerical range endpoint by providing that a given value may be “slightly above” or “slightly below” the endpoint without affecting the desired result. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50. All possible combinations of numerical values between and including the lowest value and the highest value enumerated are to be considered to be expressly stated in this disclosure.

As used herein, the term “residue” refers generally to the part of a monomer or other chemical unit that has been incorporated into a polymer or large molecule. Similarly, polymer “comprises” or is “derived from” a stated monomer if that monomer is incorporated into the polymer. Thus, the incorporated monomer that the polymer comprises is not the same as the monomer prior to incorporation into a polymer, in that at the very least, certain terminal groups are incorporated into the polymer backbone. However, the polymer may be said to include or comprise the residue of that monomer. A polymer is said to comprise a specific type of linkage if that linkage is present in the polymer.

As used herein to refer to a molecule or functional group, the term “linear” refers to a molecule or functional group that does not possess branching units; similarly, a molecule or functional group may be referred to herein as “substantially linear” where the mole fraction of branching units does not exceed 2% of the molecule or functional group.

Further, as used herein, the terms “aliphatic” or “aliphatic group” are used to refer to an optionally substituted, non-aromatic hydrocarbon moiety, unless otherwise indicated. The moiety may be, for example, linear, branched, or cyclic (e.g., mono or polycyclic such as fused, bridging, or spire-fused polycyclic), or a combination thereof. Unless otherwise specified, aliphatic groups contain 1-20 carbon atoms. As used herein, the term “alkyl” or “alkyl group” refers to both branched and straight-chain saturated aliphatic hydrocarbon chains or groups. These groups can have a stated number of carbon atoms, expressed as Cx-y or Cx-Cy, where x and y typically are integers. For example, C₅₋₁₀ or C₅-C₁₀, includes C₅, C₅, C₇, C₈, C₉, and C₁₀. As used herein, the terms “alkanediyl” and “alkandiyl group” refer to a series of divalent radicals of the general formula —CrₙH₂ₙ— derived from aliphatic hydrocarbons.

Similarly, the terms “alkene” or “alkene group” are used herein to refer to both straight- and branched-chain alkyl groups having one or more carbon-carbon double bonds.

The terms “alkyne” or “alkyne group” refer to a group having a carbon-carbon triple bond and the terms “alkynyl” is used herein to refer to both straight- and branched-chain alkyl groups having one or more carbon-carbon triple bonds. As used herein, the term “alkyne functionalized” refers a compound having one or more chemically active alkyne bonds.

The term “aryl” as used herein refers to an aromatic, carbocyclic system, e.g., of about 6 to 14 carbon atoms, which can include a single ring or multiple aromatic rings fused or linked together where at least one part of the fused or linked rings forms the conjugated aromatic system. The aryl groups include, but are not limited to, phenyl, naphthyl, biphenyl, anthryl, tetrahydronaphthyl, phenanthryl, indene, benzonaphthyl, and fluorenyl.

As used herein, the term “3D printable,” as applied to a polymer or copolymer, refers to a polymer or copolymer that can be used alone or with other ingredients such as diethyl fumarate (DEF), crosslinkers, diluents, photoinitiators, dyes, light attenuating agents, dispersants, emulsifiers, ceramics, BIOGLASS™, hydroxyapatite, β-tricalcium phosphate, and/or solvents to form a resin capable of be printed into a 3 dimensional structure using conventional additive manufacturing (3D printing) technologies. As follows, the term “3D printable polymer resin” refers to a polymer resin capable of be printed into a 3-dimensional structure using conventional additive manufacturing (3D printing) technologies.

Further, as used herein, the term “block” or “block polymer” in the context of a polymer refers to a polymer chain having a substantially uninterrupted sequence of repeating monomer units and the term “block copolymer” refers to a polymer or co polymer consisting essentially of two or more such blocks. Similarly, the terms “ABA triblock copolymer,” “ABA triblock polymer,” ABA block copolymer,” and “ABA block polymer” are used interchangeably to refer to a block copolymer having two substantially identical polymer blocks (A blocks) separated by and bonded to a different polymer block (block).

As used herein, the term “non-crystalline” when used in connection with a poly(lactone) or lactone monomer refers to a poly(lactone) that exhibits no melt transition endotherm and/or a lactone monomer used to form such a poly(lactone).

As used herein, the term “initiator” is used herein to refer to a molecule having at least one functional group that initiates ring opening polymerization and/or ring opening copolymerization in the presence of a catalyst and is incorporated into the resulting polymer chain. As follows, the terms “divalent initiator” and/or “bivalent initiator” used herein interchangeably to refer to an initiator that has two functional groups that initiates ring opening polymerization and/or ring opening copolymerization in the presence of a catalyst. In one or more embodiment, the terms “divalent initiator” and/or “bivalent initiator” used herein interchangeably to refer to an initiator that has two reactive hydroxyl (—OH) or carboxylic acid (—COON) groups that initiate ring opening polymerization and/or ring opening copolymerization in the presence of a catalyst.

As used herein, “photochemically crosslinking” refers to the process of crosslinking polymer chains by application of electromagnetic waves, generally ultraviolet light waves. Similarly, the term “covalently crosslinked elastic network” refers to an elastomeric network formed by photochemical crosslinking.

As used herein, the “total” DPₙ of the poly(lactone) B block polymer segment refers to the combined DPₙ of both poly(lactone) chains forming the B block polymer segment.

The term “degradable” as applied to a polymer or copolymer, means that the polymer or copolymer will, degrade either partially or completely through chemical reactions, such as acid/base reactions, hydrolysis reactions, and enzymatic cleavage when placed in a living organism. Unless otherwise indicated, “degradation products” are atoms, radicals, cations, anions, or molecules other than water formed as the result of hydrolytic, oxidative, enzymatic, or other chemical processes. As used herein, a “biodegradable” material is one which decomposes under normal in vivo physiological conditions into components which can be metabolized or excreted. Similarly, as used herein, a “biocompatible” material is one which stimulates only a mild, often transient, implantation response, as opposed to a severe or escalating response and a “bioresorbable” material is one that breaks down over a finite period of time due to the chemical/biological action of the body.

As used herein, the terms “isomerization,” “isomerized,” or “isomerize” refer broadly to the conversion of the cis-isomer (PPM) to its trans-isomer (PPF) form or, in the context of a chemical reaction or process (an “isomerization reaction”) to a reaction or process that converts the cis-isomer (PPM) to its trans-isomer (PPF) form. While the isomerization step does result in some other changes to the polymer, it should be apparent that most general aspects of the PPF polymers such as the approximate Mₙ, Dₘ, and T_{g} ranges do not appreciably change during isomerization.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. However, reference to cited material or information contained in the text should not be understood as a concession that the material or information was part of the common general knowledge or was known in the United States or any other country. In the case of a conflict, the present disclosure, including definitions, will control. All technical and scientific terms used herein have the same meaning, unless otherwise indicated.

Further, any compositions or methods provided herein can be combined with one or more of any of the other compositions and methods provided herein. The fact that given features, elements or components are cited in different dependent claims does not exclude that at least some of these features, elements or components maybe used in combination together. Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

In a first aspect, the present invention is directed to an ABA triblock copolymer having cross-linkable poly(propylene fumarate) A blocks and a poly(lactone) B block, as described below. In various embodiments, the ABA triblock copolymers of the present invention comprise a B polymer block comprising two poly(lactone) chains extending outward from the residue of a divalent initiator and a first and second poly(propylene fumarate) A polymer block covalently bonded at each end of the poly(lactone) B block to form an ABA block copolymer. The A blocks contain poly(propylene fumarate) (PPF) which is photocrosslinkable in numerous 3D printing systems and is known to degrade in the body to non-toxic fumaric acid (a Krebs-cycle constituent) and propylene glycol (a ubiquitous food additive) residues. The flexible poly(lactone) B polymer blocks are not photocrosslinkable and are softer and more flexible than the PPF A polymer blocks.

The poly(lactone) B block polymers are non-crystalline and help to reduce the viscosity of the polymer and with it the amount of diluent solvent needed to form a 3D printable resin. Generally speaking, the longer the poly(lactone) B polymer blocks the lower the viscosity of the ABA triblock copolymer will be. Conversely, however, In addition, it has been found that these poly(lactone) B polymer blocks do not suppress water transport within the crosslinked polymer facilitating even degradation throughout the polymer. Further, the poly(lactone) B block affords more solubility in a number of solvents and lower viscosity due to the breakup of the conjugated backbone.

As set forth above and will be discussed in more detail below with respect to the inventive methods of the present invention, the B block of the ABA triblock copolymers of the present invention are formed by the magnesium catalyzed ring opening polymerization of one or more lactone monomers around a divalent initiator molecule having two hydroxyl, thiol, or carboxylic acid groups. The ring opening polymerization reaction will initiate at these functional groups and form two poly(lactone) chains of generally comparable lengths extending outward from the residue of the divalent initiator molecule and having a terminal hydroxyl group. As will be apparent, the subsequent ring open copolymerization reaction that forms the A blocks of the ABA triblock copolymers of the present invention will initiate at these the terminal hydroxyl groups of the B polymer block.

In various embodiments, the B block polymer segment of the ABA triblock copolymers of the present invention will comprise a two poly(lactone) chains and the residue of the divalent initiator. By way of example, if γ-methyl-ε-caprolactone is used as the lactone monomer, the poly(lactone) B block polymer segment will have the general formula:

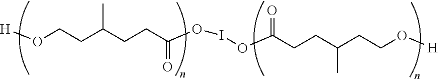

where I is the residue of the divalent initiator used to initiate the lactone polymerization and n is the number of lactone units, generally from about 5 to about 25.

As will be apparent, the overall length of the B polymer block will be equal to the length of the divalent initiator plus the lengths of the two poly lactone segments extending therefrom. It follows, further, that the length of the two poly(lactone) segments will depend on the upon their degree of polymerization (DPₙ) and, to a lesser extent, the ring size of the lactone monomers that were used to form them. As set forth above, the “total” degree of polymerization (DPₙ) of the B polymer block will be equal to the length of both poly(lactone) segments (about 2n).

In various embodiments, a two poly(lactone) segments of the B block polymer segment of the ABA triblock copolymers of the present invention will have a total degree of polymerization (DPₙ) of from about 5 to about 50, preferably from about 5 to about 20, and more preferably from about 5 to about 10. In some embodiments, the B block polymer segment of the ABA triblock copolymers of the present invention will comprise a poly(lactone) segment having a degree of polymerization (DPₙ) of from about 5 to about 45, in other embodiments, from about 5 to about 35, in other embodiments, from about 5 to about 25, in other embodiments, from about 5 to about 15, in other embodiments, from about 10 to about 50, in other embodiments, from about 20 to about 50, in other embodiments, from about 30 to about 50, and in other embodiments, from about 40 to about 50. Here, as well as elsewhere in the specification and claims, individual range values can be combined to form additional non-disclosed ranges.

Any lactone monomer that undergoes ring opening polymerization using a magnesium catalyst, such as Mg(BHT)₂(THF)₂, and a divalent initiator to produce a non-crystalline poly(lactone) as described below may be used. It should be noted, however, that lager, bulkier lactone monomers will tend to react more slowly, thereby slowing initiation of the polymerization reaction.

Suitable lactone monomers include, without limitation, α-chloro-ε-caprolactone, 4-chloro-ε-caprolactone, 4-methyl-7-isopropyl-ε-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-heptalactone, ε-decalactone macrolactones, ω-pentadecalactone (PDL), functional lactones, θ-propargyl-ε-nonalactone (θρεNL), α-propargyl-ε-caprolactone (αρεCL), and combinations thereof. In one or more embodiments, the B polymer block comprises lactone units formed using γ-methyl-ε-caprolactone as the monomer.

Similarly, the divalent initiator chosen is not particularly limited provided that it has at least two reactive hydroxyl, thiol or carboxylic acid groups and does not otherwise interfere with the reaction. In one or more embodiments, the divalent initiator may be one or more C₂ to C₂₀ diol, C₂ to C₂₀ dithiol, or C₂ to C₂₀ dicarboxylic acid. Suitable initiators may include, without limitation, fumaric acid (FmA), succinic acid, 1,4-cyclohexnadicarboxylic acid (CHDA), 1,4-dimethoxy cyclohexane (CHDM), 1,4-dimethoxy benzene (BDM), cis-but-2-ene-1,4-diol ((Z)-but-2-ene-1,4-diol) (cBD), but-2-yne-1,4-diol (BYD), 1,4-butanediol, 1,5-pentanediol, 1,6-hexanediol (HD), 1,8-octanediol, 1,10-decanediol, 1,12-dodecandiol (DD), or a combination thereof.

In one or more embodiments, the divalent initiator may have one or more of the following formulas:

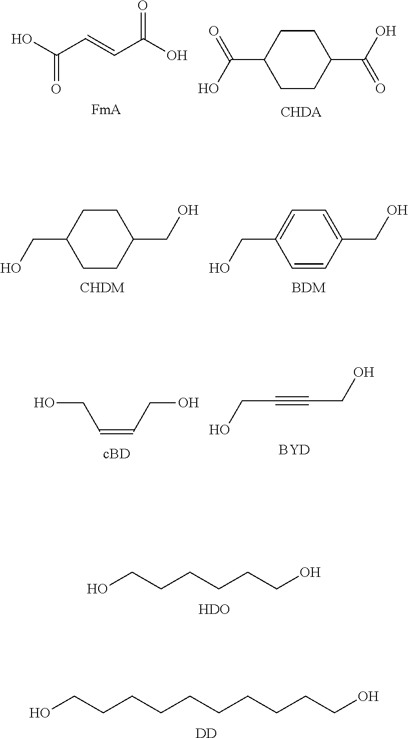

The PPF A blocks are covalently bonded to both ends of the poly(lactone) B block segments. In various embodiments, each A block will comprise a poly(propylene fumarate) segment having a degree of polymerization (DPₙ) of from about 5 to about 30, preferably from about 5 to about 20, and more preferably from about 5 to about 10. In some embodiments, A block will comprise a poly(propylene fumarate) segment having a degree of polymerization (DPₙ) of from about 5 to about 25, in other embodiments, from about 5 to about 20, in other embodiments, from about 5 to about 15, in other embodiments, from about 5 to about 10, in other embodiments, from about 10 to about 30, in other embodiments, from about 15 to about 30, in other embodiments, from about 20 to about 30, and in other embodiments, from about 25 to about 30. Here, as well as elsewhere in the specification and claims, individual range values can be combined to form additional non-disclosed ranges.

In various embodiments, the ratio of the degree of polymerization (DPₙ) of the first A polymer block to the B polymer block to the second A polymer block is from 5:10:5 to 5:50:5, preferably from about 5:10:5 to 5:30:5, and more preferably from about 5:10:5 to 5:20:5. In some embodiments, the ratio of DPₙ of the first A polymer block to the B polymer block to the second A polymer block is from 5:10:5 to 5:45:5, in other embodiments, from about 5:10:5 to about 5:40:5, in other embodiments, from about 5:10:5 to about 5:35:5, in other embodiments, from about 5:10:5 to about 5:30:5, in other embodiments, from about 5:10:5 to about 5:25:5, in other embodiments, from about 5:10:5 to about 5:20:5, and in other embodiments, from about 5:10:5 to about 5:15:5. In various embodiments, the ratio of the degree of polymerization of the first A polymer block to the B polymer block to the second A polymer block is from about 5:10:5 or about 5:20:5.

In one or more embodiments, the ABA triblock copolymer of the present invention will comprise from about 1% to about 50 mol % fumarate units. In some embodiments, the ABA triblock copolymer of the present invention will comprise from about 1% to about 45 mol %, in other embodiments, from about 1 mol. % to about 35 mol. %, in other embodiments, from about 1 mol. % to about 25 mol. %, in other embodiments, from about 1 mol. % to about 15 mol. %, in other embodiments, from about 1 mol. % to about 7 mol. %, in other embodiments, from about 5 mol. % to about 50 mol. %, in other embodiments, from about 10 mol. % to about 50 mol. %, in other embodiments, from about 20 mol. % to about 50 mol. %, and in other embodiments, from about 35 mol. % to about 50 mol. % fumarate units Here, as well as elsewhere in the specification and claims, individual range values can be combined to form additional non-disclosed ranges.

In one or more embodiments, the ABA triblock copolymer of the present invention will have the formula:

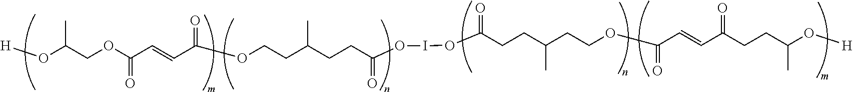

where each n is an integer from about 5 to about 25, each m is an integer from about 5 to about 30, and I is the residue of the divalent initiator. In some of these embodiments, n is an integer from about 5 to about 20, in other embodiments, from about 5 to about 10, in other embodiments, from about 10 to about 25, in other embodiments, from about 15 to about 25, and in other embodiments, from about 20 to about 25. In some embodiments, m is an integer from about 5 to about 25, in other embodiments, from about 5 to about 20, in other embodiments, from about 5 to about 15, in other embodiments, from about 5 to about 10, in other embodiments, from about 10 to about 30, in other embodiments, from about 15 to about 30, in other embodiments, from about 20 to about 30, and in other embodiments, from about 25 to about 30. Here, as well as elsewhere in the specification and claims, individual range values can be combined to form additional non-disclosed ranges.

In one or more embodiments, the ABA triblock copolymer of the present invention will have the formula:

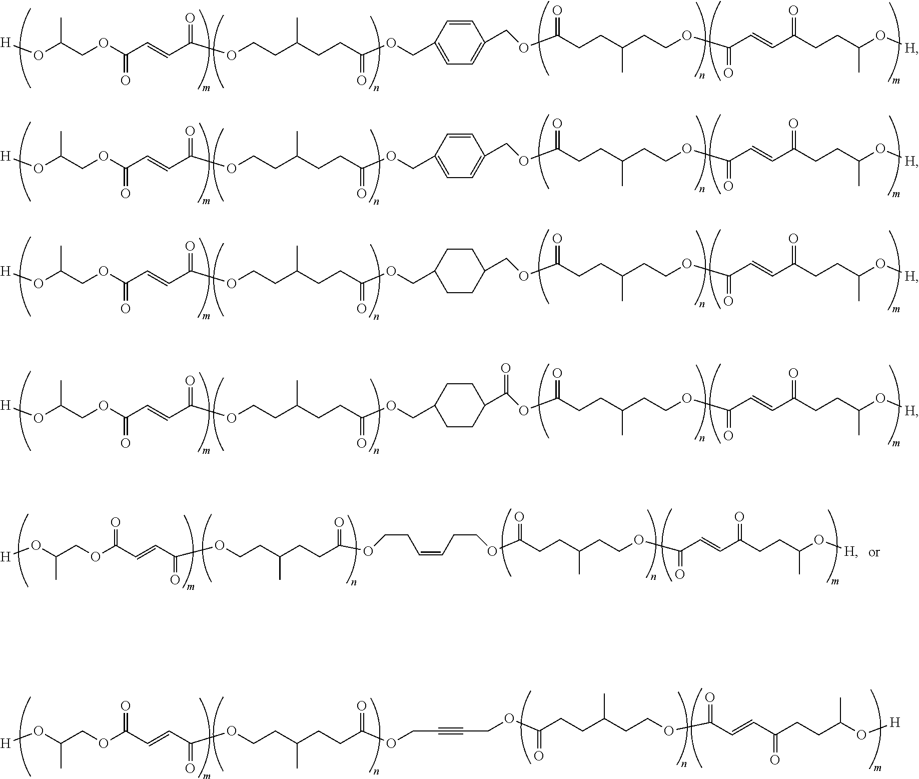

where each n is an integer from about 5 to about 25 and each m is an integer from about 5 to about 30. In various embodiments, n and m may be as set forth above. Here, as well as elsewhere in the specification and claims, individual range values can be combined to form additional non-disclosed ranges.

In one or more other embodiments, the ABA triblock copolymer of the present invention will have the formula:

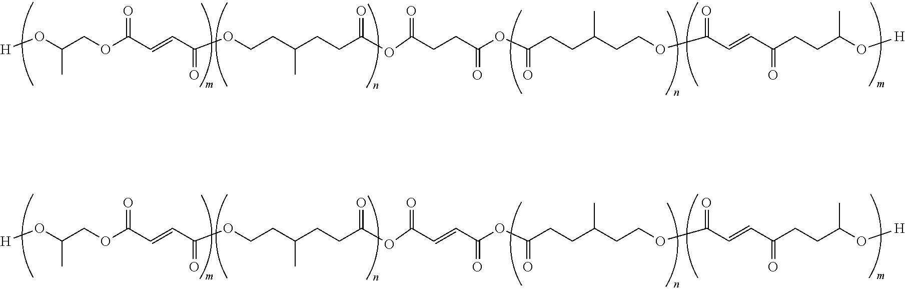

where each n is an integer from about 5 to about 25 and each m is an integer from about 5 to about 30. In various embodiments, n and m may be as set forth above. Here, as well as elsewhere in the specification and claims, individual range values can be combined to form additional non-disclosed ranges.

In some other embodiments, the ABA triblock copolymer of the present invention will have the formula:

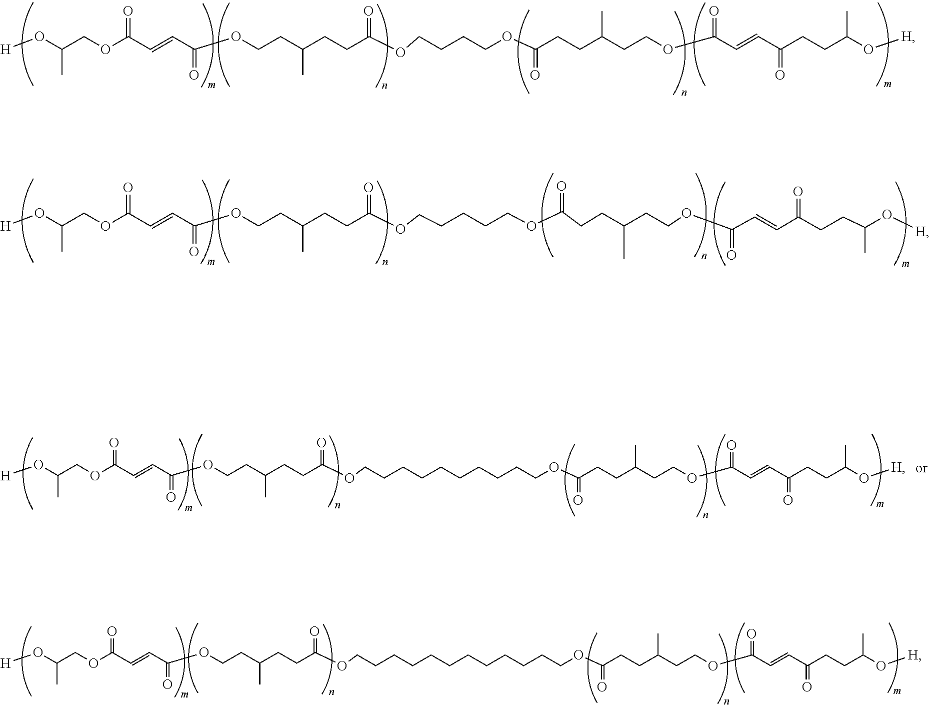

where each n is an integer from about 5 to about 25 and each m is an integer from about 5 to about 30. In various embodiments, n and m may be as set forth above. Here, as well as elsewhere in the specification and claims, individual range values can be combined to form additional non-disclosed ranges.

In some other embodiments, the ABA triblock copolymer of the present invention will have the formula:

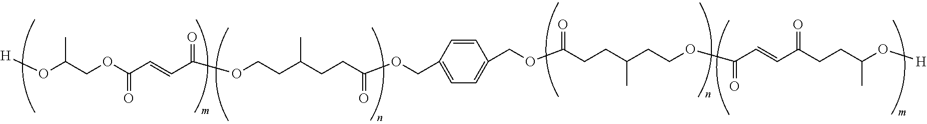

where each n is an integer from about 1 to about 25 and each m is about 5. In various embodiments, n may be as set forth above. (See, FIG. 2)

In one or more embodiment, the ABA triblock copolymer of the present invention will have a number average molecular weight (Mₙ) of from about 2.2 kDa to about 3.4 kDa as measured by ¹H NMR spectroscopic analysis of the final reaction product. In one or more embodiment, the ABA triblock copolymer of the present invention will have a weight average molecular weight (M_{w}) of from about 2.6 kDa to about 4.0 kDa as measured by ¹H NMR spectroscopic analysis of the final reaction product. In some embodiments, the ABA triblock co polymer of the present invention will have a weight average molecular weight (M_{w}) of from about 2.6 kDa to about 3.0 kDa as measured by ¹H NMR spectroscopic analysis of the final reaction product. Here, as well as elsewhere in the specification and claims, individual range values can be combined to form additional non-disclosed ranges.

In other embodiments, the ABA triblock co polymer of the present invention will have a number average molecular weight (Mₙ) of from about 3.1 kDa to about 7.8 kDa as measured by size exclusion chromatography (SEC) in CHCl₃ against polystyrene standards. Here, as well as elsewhere in the specification and claims, individual range values can be combined to form additional non-disclosed ranges.

In some embodiments, the ABA triblock copolymer of the present invention will have a weight average molecular weight (M_{w}) of from about 3.5 kDa to about 9.5 as measured by size exclusion chromatography (SEC) in CHCl₃ against polystyrene standards. Here, as well as elsewhere in the specification and claims, individual range values can be combined to form additional non-disclosed ranges.

Advantageously, the ABA triblock copolymers of the present invention feature low polydispersity. In various embodiments, the ABA triblock copolymer of the present invention will have a polydispersity (Dₘ) of from about 1.0 to 1.5 wherein Dₘ=M_{w}/Mₙ. As will be apparent, while the Mₙ and M_{w} of the ABA block copolymer may be determined using any suitable method known in the art, for purposes of determining the Dₘ, Mₙ and M_{w} should be determined by the same method. In some embodiments, for example, the Dₘ of the ABA block copolymer may be determined using Mₙ and M_{w} values measured by ¹H NMR spectroscopic analysis of the final reaction product. In some other embodiments, the Dₘ of the ABA block copolymer may be determined using Mₙ and M_{w} values measured by size exclusion chromatography (SEC) in CHCl₃ against polystyrene standards.

In various embodiments, the polydispersity Oₘ of the ABA triblock copolymers of the present invention will be 1.5 or less. In some embodiments, the ABA triblock copolymer of the present invention will have a polydispersity Oₘ of from about 1.0 to 1.5, in other embodiments, from about 1.0 to about 1.4, in other embodiments, from about 1.0 to about 1.3, in other embodiments, from about 1.0 to about 1.2, in other embodiments, from about 1.0 to about 1.1, in other embodiments, from about 1.1 to about 1.5, in other embodiments, from about 1.2 to about 1.5, in other embodiments, from about 1.3 to about 1.5, and in other embodiments, from about 1.4 to about 1.5. Here, as well as elsewhere in the specification and claims, individual range values can be combined to form additional non-disclosed ranges.

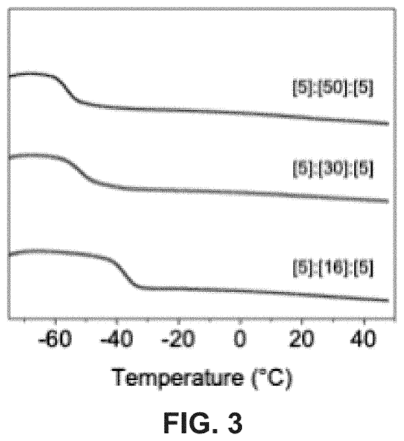

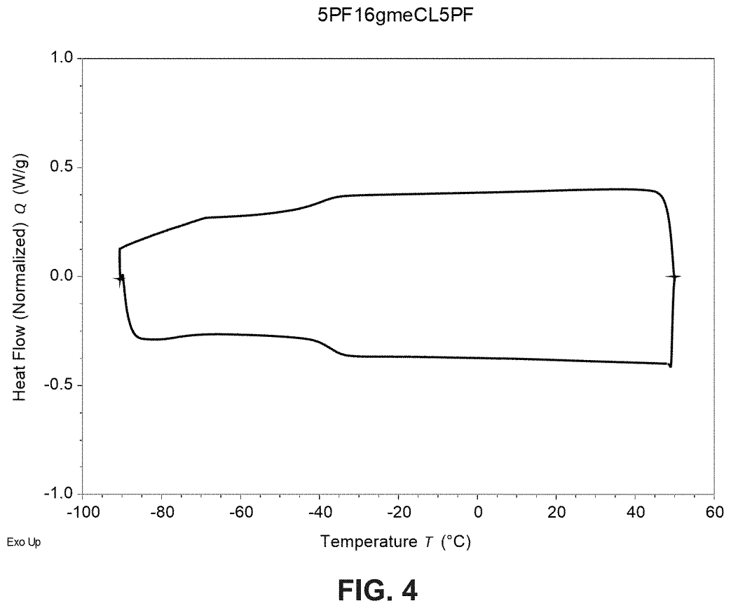

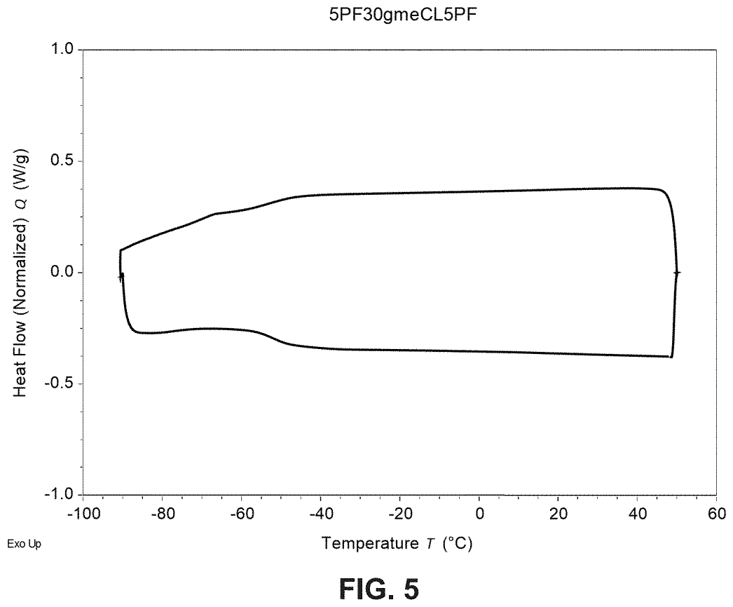

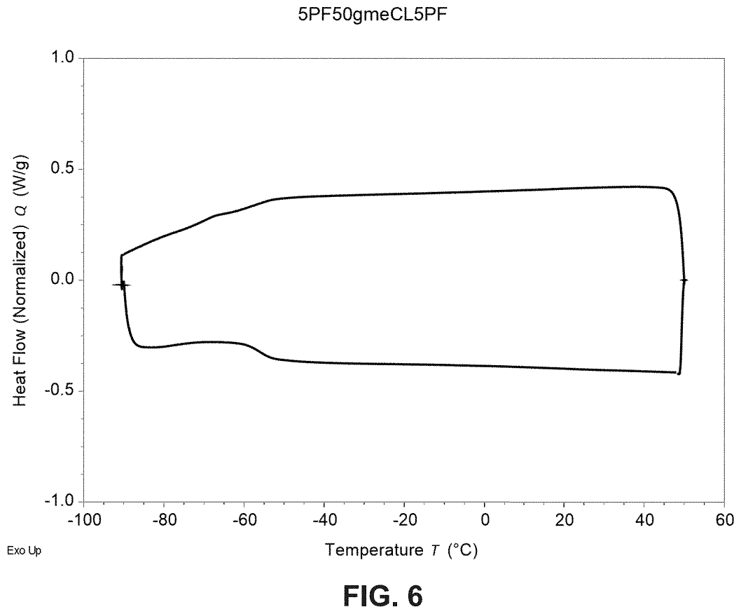

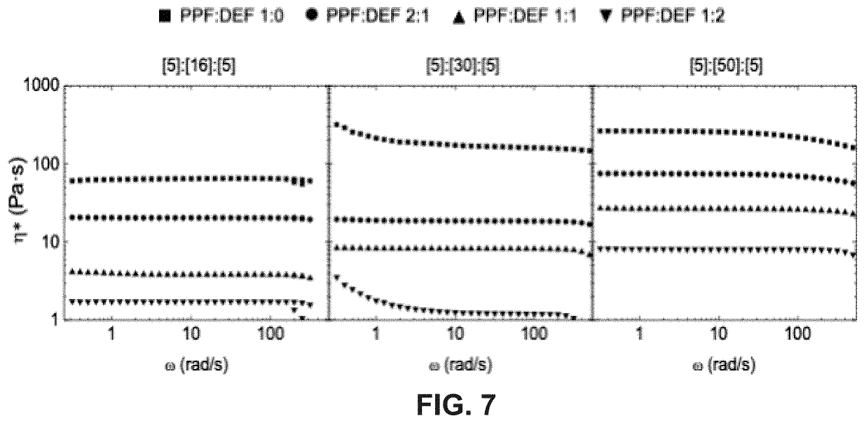

In various embodiments, the polymers ABA triblock copolymer of the present invention are amorphous, having glass transition temperatures (T_{g}) well below room temperature. (See, FIGS. 3-6). As will be appreciated, the T_{g} of these polymers will depend, at least in part, upon the size of poly(lactone) B blocks relative to the more glassy PPF A blocks in the polymer. All other things being equal, it has been found that the T_{g}, of the ABA triblock copolymer of the present invention, will decrease as the degree of polymerization (DPₙ) of the poly(lactone) B block increases.

In various embodiments, the ABA block copolymers of the present invention will have a glass transition temperature (T_{g}) of from about −30° C. to about −60° C., preferably from about −40° C. to about −60° C., and more preferably from about −50° C. to about −60° C., as measured by differential scanning calorimetry (DSC). (See, FIGS. 3-6). Here, as well as elsewhere in the specification and claims, individual range values can be combined to form additional non-disclosed ranges.

While, as set forth above, the T_{g} of the ABA triblock copolymers of the present invention decreased as the size of the poly(lactone) B block increases, the complex viscosity (η*) was found to increase as the size of the poly(lactone) B block increases. This suggests that the viscosity of the materials is primarily influenced by the molecular mass of the copolymer, rather than the A:B:A block ratio. The complex viscosity of the ABA triblock copolymers of the present invention may be measured using a suitable rheometer, as is known in the art. In some embodiments, the complex viscosity of the ABA triblock copolymers of the present invention may be measured using a Discovery Series Hybrid Rheometer (TA Instruments, New Castle, Del.) with 20 mm parallel plate geometry and a 500 μm gap.

The polymers described herein are said to be degradable or biodegradable. By that, it is meant that the polymer, once implanted and placed in contact with bodily fluids and tissues, or subjected to other environmental conditions, such as composting, will degrade either partially or completely through chemical reactions, typically and often preferably, over a time period of hours, days, weeks or months. Non-limiting examples of such chemical reactions include acid/base reactions, hydrolysis reactions, and enzymatic cleavage. The polymers described herein contain labile ester linkages. The polymer or polymers may be selected so that it degrades over a time period. Non-limiting examples of useful in situ degradation rates include between 12 hours and 5 years, and increments of hours, days, weeks, months or years therebetween.

Preferably, the polymers for use with the present invention are materials which decompose when placed inside an organism. This can be observed as a decline in the molecular weight of the polymer over time. Polymer molecular weights can be determined by a variety of methods including size exclusion chromatography (SEC), and are generally expressed as weight averages or number averages. A polymer is biodegradable if, when in phosphate buffered saline (PBS) of pH 7.4 and a temperature of 37° C., its weight-average molecular weight is reduced by at least 25% over a period of 6 months as measured by SEC.

Resins prepared using DEF, in particular, produce polymers shown to undergo slow, hydrolytic degradation in vitro with minimal loss of mechanical performance during degradation. While the ABA triblock copolymers are themselves degradable, photo-crosslinking with DEF results in a carbon-carbon bond network which is not degradable. This network persists long after the other ester bonds of the aba triblock copolymers have degraded and will likely remain long after (probably for the life of the organism) the desired time and prevent the remodeling of the tissue where the construct is embedded. Resins made using other solvents (i.e., without DEF) can be printed to form structures that are fully degradable, but lack the mechanical strength of the printed structures made using DEF.

In a second aspect, the present invention is directed methods for making the ABA triblock copolymers described above. In one or more embodiments, the method for making an ABA triblock copolymer comprises the steps of: (i) reacting a lactone monomer, a divalent initiator having at least two reactive hydroxyl, thiol or carboxylic acid groups, and a catalyst to form a poly(lactone) B block polymer segment having a first and second end, the first and second ends having a reactive hydroxyl or carboxylic acid group; (ii) reacting the poly(lactone) B block polymer segment with maleic anhydride, propylene oxide, and a catalyst to form a first poly(propylene maleate) polymer A block covalently bonded to and extending outward from the first end of the poly(lactone) B block polymer segment and a second poly(propylene maleate) polymer A block covalently bonded to and extending outward from the second end of the poly(lactone) B block polymer segment to form an ABA triblock copolymer intermediate having two poly(propylene maleate) A blocks and a poly(lactone) B block; and isomerizing the ABA triblock copolymer intermediate to form an ABA triblock copolymer having two crosslinkable poly(propylene fumarate) A blocks and a poly(lactone) B block.

In the first step (step i), involves the ring opening polymerization of one or more lactone monomers with a bivalent initiator to form the poly(lactone) B polymer block as shown in Scheme 1, below.

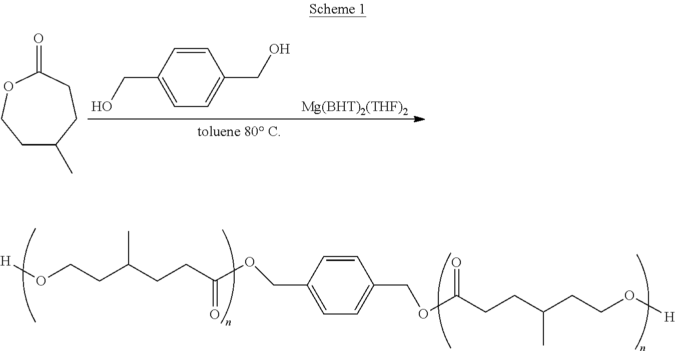

First, the lactone monomer or monomers, the bivalent initiator, and Mg(BHT)₂(THF)₂ catalyst are placed in a reaction vessel and dissolved in a suitable solvent and heated at ambient pressure and under an inert atmosphere to a reaction temperature of from about 50° C. to about 90° C. for a period of from about 18 h to about 36 h. As can be seen in Scheme 1, the lactone ring is opened by the hydroxyl initiator (activated by the catalyst) which leads to an ester formation and as a result the poly(lactone) B block polymer segments will always have a terminal hydroxyl group.

Lactone monomers capable of ring opening polymerization using Mg(BHT)₂(THF)₂ as a catalyst and a hydroxyl or carboxylic acid initiator are well known in the art. However, as the ABA triblock copolymers of the present invention crosslink to form an elastomer having a soft and flexible B block, not all lactone monomers are suitable for the claimed method. Preferably, only lactone monomers that polymerize to form a substantially non-crystalline poly(lactone) polymers should be used. Suitable lactone monomers for use in forming the B block of the ABA triblock copolymer may include, without limitation, δ-valerolactone, ε-caprolactone, α-chloro-ε-caprolactone, 4-chloro-!-caprolactone, 4-methyl-7-isopropyl-e-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-heptalactone, ε-decalactone macrolactones, ω-pentadecalactone (PDL), functional lactones, 6-propargyl-ε-nonalactone (θρεNL), α-propargyl-ε-caprolactone (apeCL), and combinations thereof. In one or more embodiments, the lactone monomer is γ-methyl-ε-caprolactone. Most often, a single lactone monomer will be used, but the invention is not so limited and there are embodiments where two or more lactone monomers may be used within the scope of the invention.

Similarly, the divalent initiator chosen is not particularly limited provided that it has at least two reactive hydroxyl or carboxylic acid groups and does not otherwise interfere with the reaction. In one or more embodiments, the divalent initiator may be one or more C₂ to C₂₀ diol, C₂ to C₂₀ dithiol, or C₂ to C₂₀ dicarboxylic acid. Suitable initiators may include, without limitation, fumaric acid (FmA), succinic acid, 1,4-cyclohexnadicarboxylic acid (CHDA), dimethoxy cyclohexane (CHDM), 1,4-dimethoxy benzene (BDM), cis-butane-2-diol (cis-BD), butyn-2-diol (BYD), 1,4-butanediol, 1,5-pentanediol, 1,6-hexanediol (HD), 1,8-octanediol, 1,10-decanediol, 1,12-dodecandiol (DD), or a combination thereof.

In one or more embodiments, the divalent initiator may have one or more of the following formulas:

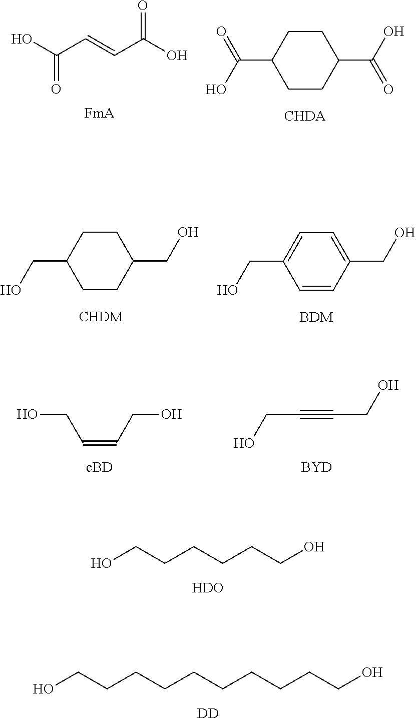

The reaction solvent used is not particularly limited provided it is a solvent for all of the lactone monomer and bivalent initiator and Mg(BHT)₂(THF)₂, does not react with any of the reagents or impede the ring opening polymerization reaction. Suitable solvents may include without limitation, toluene, tetrahydrofuran, methyl-tetrahydrofuran and combinations thereof. One of ordinary skill in the art will be able to select a suitable reaction solvent without undue experimentation.

While the ring opening polymerization reaction will proceed, if very slowly, at ambient temperature, the reaction vessel is preferably heated to a temperature of from about 50° C. to about 90° C., preferably from about 60° C. to about 90° C., and more preferably from about 70° C. to about 90° C. In some embodiments, the reaction vessel is preferably heated to a temperature of about 80° C.

In various embodiments, the reaction vessel is heated and the reaction continued until substantially all of the lactone monomer has reacted. In one or more embodiments, the reaction vessel is heated and the reaction continued for approximately 24 hours. In some other embodiments, the reaction may be quenched with a strong acid before all of the lactone monomer has reacted.

In various embodiments, the quantity of lactone monomers used and/or the reaction time may be controlled in such a way as to produce a poly(lactone) B block polymer segment having a total degree of polymerization (DPₙ) (i.e. the DP for both poly(lactone chains) of from about 5 to about 50. In some embodiments, the total DPₙ of the poly(lactone) B block polymer segment will be from about 5 to about 45, in other embodiments, from about 5 to about 35, in other embodiments, from about 5 to about 25, in other embodiments, from about 5 to about 15, in other embodiments, from about 5 to about 10, in other embodiments, from about 10 to about 50, in other embodiments, from about 20 to about 50, in other embodiments, from about 30 to about 50, and in other embodiments, from about 40 to about 50. In some embodiments, the poly(lactone) B block polymer segment will have a total DPₙ of about 10. In some other embodiments, the poly(lactone) B block polymer segment will have a total DPₙ of about 20 Ordinarily, the DPₙ of the poly(lactone) B block polymer segment will be controlled by using a stoichiometric amount of lactone monomer calculated to produce the desired total DPₙ and allowing the polymerization reaction to go to completion.

In some embodiments, the lactone monomer will be γ-methyl-ε-caprolactone and the poly(lactone) B block polymer segment formed in the ring-opening polymerization reaction will have the general formula:

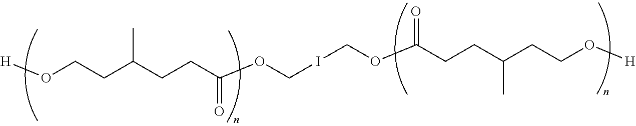

where I is the residue of the divalent initiator used to initiate the lactone polymerization and n is an integer from about 5 to about 25. In various embodiments, n may be as set forth above with respect to the ABA triblock copolymer.

In the embodiment shown in Scheme 1, above, the lactone monomer is γ-methyl-ε-caprolactone, the divalent initiator is 1,4-dimethoxy benzene (BDM), the catalyst is Mg(BHT)₂(THF)₂, and the reaction solvent is toluene. In these embodiments, the reaction vessel is heated to about 80° C. and allowed to continue for 24 h at ambient pressure under a N₂ atmosphere to produce a poly(lactone) B block polymer segment having the formula:

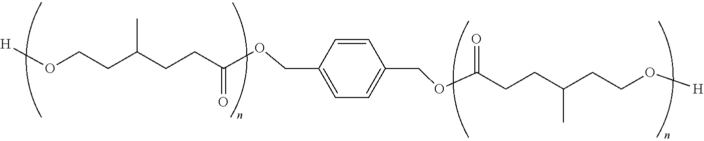

where each n is an integer from about 5 to about 25. In various embodiments, n may be as set forth above with respect to the ABA triblock copolymer.

In some embodiments, a poly(lactone) B block polymer segments are used as is in the second step described below. In some embodiments, the poly(lactone) B block polymer segment may be collected and purified using known methods for later use. In these embodiments, the poly(lactone) B block polymer is used as a bivalent initiator for the ring opening copolymerization reaction that forms PPF A blocks, as set forth below.

In the second step of the method (step ii), the PPF A polymer blocks are added onto either end of the poly(lactone) B block polymer segment formed in step (i) by ring-opening copolymerization of maleic anhydride and propylene oxide as shown in Scheme 2 below to produce an ABA triblock copolymer intermediate having two poly(propylene maleate) A blocks and a poly(lactone) B block.

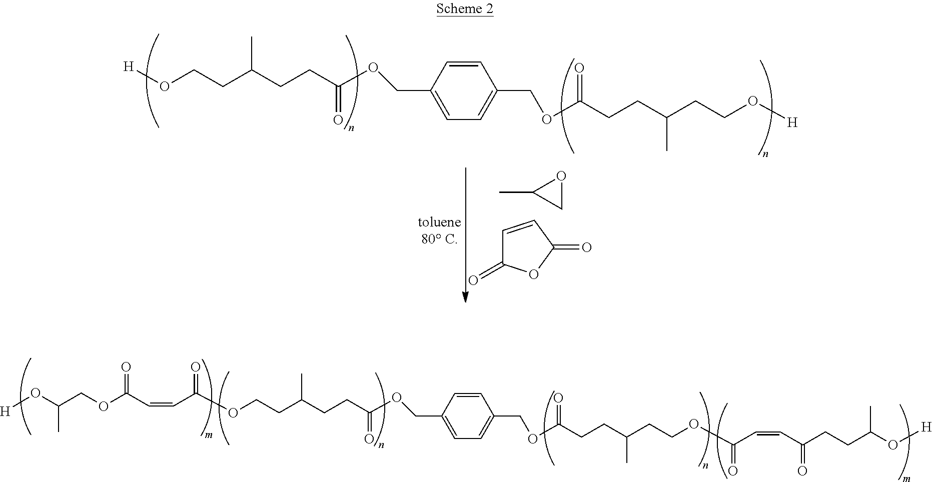

As set forth above, the poly(lactone) B block polymer segment formed in step (i) will have terminal hydroxyl groups on the ends of both of its lactone chains and can therefore act as a bivalent initiator for the ring-opening copolymerization reaction of step (ii). In some embodiments, the reaction vessel containing the poly(lactone) B block polymer segment formed above is next allowed to cool before maleic anhydride and propylene oxide are added. As will be apparent, the maleic anhydride and propylene oxide are added at a stoichiometric molar ratio of about 1:1. However, in some embodiments, a slight excess of propylene oxide may be added in order to drive the reaction to completion.

Since the Mg(BHT)₂(THF)₂ catalyst was not consumed in the first reaction and is present in the reaction vessel, it is not generally necessary to add additional catalyst to the reaction vessel for the second reaction. If necessary, additional toluene may be added to maintain the reaction concentration at about 7 M. However, in some other embodiments, as set forth above, the poly(lactone) B block polymer segment from the 1^{st} reaction has been collected for later use and the reaction solvent and catalyst are no longer present with the poly(lactone) B block polymer. In these embodiments, the poly(lactone) B block polymer functions as a bivalent initiator and additional quantities of the reaction solvent and Mg(BHT)₂(THF)₂ catalyst will need to be added to the reaction vessel along with the maleic anhydride and propylene oxide monomers.

In various embodiments he reaction vessel is then heated to begin the alternating ring-opening copolymerization of the maleic anhydride and propylene oxide to produce the propylene maleate A blocks as showed in Scheme 2 above. The reaction is allowed to proceed until substantially all of the propylene oxide and maleic anhydride or the reaction is quenched with a strong acid, such as hydrochloric or sulfuric acid. The reaction time will depend upon the reaction conditions and the quantity of reagents used, but is generally from about 6 h to about 96 h. In some embodiments, the reaction time will be from about 24 h to about 96 h, in other embodiments, from about 48 h to about 96 h, and in other embodiments, from about 72 h to about 96 h. In some embodiments, the reaction time is about 4 days.

In some embodiments, the alternating ring-opening copolymerization may be terminated by quenching in liquid nitrogen.

The resulting polymer will have a first poly(propylene maleate) polymer A block covalently bonded to and extending outward from an end of the poly(lactone) B block polymer segment and a second poly(propylene maleate) polymer A block covalently bonded to and extending outward from the other end of the poly(lactone) B block polymer segment, thereby forming a ABA triblock copolymer intermediate having two poly(propylene maleate) A blocks and a poly(lactone) B block. The ABA triblock copolymer intermediate may be collected and purified using any appropriate method known in the art for that purpose. In some embodiments, the ABA triblock copolymer intermediate may be collected by precipitation in to a non-solvent for the polymer. In some of these embodiments, the ABA triblock copolymer intermediate may be recovered by precipitation into hexanes.

In various embodiments, the quantity of maleic anhydride and propylene oxide monomers used and/or the reaction time may be controlled in such a way as to produce a poly(propylene maleate) A block polymer segments having a degree of polymerization (DPₙ) of from about 5 to about 30. In some embodiments, the A block segments will have a DPₙ of from about 5 to about 25, in other embodiments, from about 5 to about 20, in other embodiments, from about 5 to about 15, in other embodiments, from about 5 to about 10, in other embodiments, from about 10 to about 30, in other embodiments, from about 15 to about 30, in other embodiments, from about 20 to about 30, and in other embodiments, from about 25 to about 30. In some embodiments, the A polymer blocks will have a DPₙ of about 5. Ordinarily, the DPₙ of the poly(propylene maleate) A polymer blocks will be controlled by using a stoichiometric amount of the maleic anhydride and propylene oxide monomers calculated to produce the desired DPₙ and allowing the polymerization reaction to go to completion.

In various embodiments, the ratio of the degree of polymerization (DPₙ) of the first poly(propylene maleate) polymer A block to the total DPₙ of the poly(lactone) B block polymer segments to the degree of polymerization DPₙ of the second poly(propylene maleate) polymer A block is from 5:10:5 to 5:50:5, preferably from about 5:10:5 to 5:30:5, and more preferably from about 5:10:5 to 5:20:5. In various embodiments, the ratio of the degree of polymerization of the first A polymer block to the B polymer block to the second A polymer block is from about 5:10:5 or about 5:20:5. Advantageously, the respective block length ratios can be controlled using stoichiometry as the conversion is high.

In some embodiments, the ABA block copolymer intermediate is a poly(propylene maleate-b-γ-methyl-ε-caprolactone-b-propylene maleate) ABA triblock copolymer intermediate having the formula:

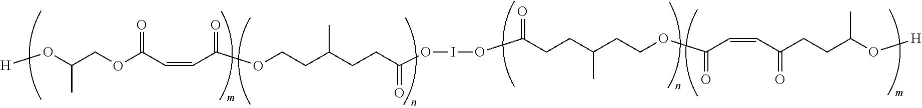

where each n is an integer from about 5 to about 25, each m is an integer from about 5 to about 30, and I is the residue of the divalent initiator.

Finally, the poly(propylene maleate) A blocks of the ABA triblock copolymer intermediate are isomerized using an organic base to form the ABA triblock copolymer having two crosslinkable poly(propylene fumarate) A blocks and a poly(lactone) B block of the present invention, as shown in Scheme 3 below.

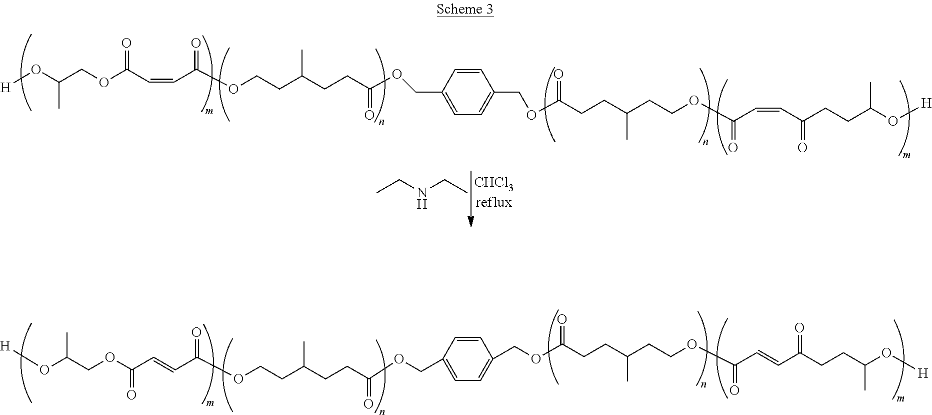

Methods for isomerization of the cis poly(propylene maleate) isomer into the trans poly(propylene fumarate using an organic base are well known in the art.

In one or more embodiments, the ABA triblock copolymer is dissolved in a suitable solvent, such as chloroform, and an organic base, such as diethylamine is added. The reaction is then heated to a reflux temperature and allowed to reflux overnight. After completion of the reaction, the diethylamine may be removed from the polymer by washing it with 0.5 M sodium phosphate buffer solution (3×). The remaining solvent may then be removed under vacuum.

In some embodiments, the ABA block copolymer is a poly(propylene fumarate-b-γ-methyl-ε-caprolactone-b-propylene fumarate) ABA block copolymer having the formula:

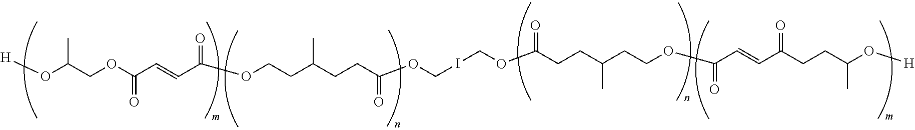

where each n is an integer from about 5 to about 25, each m is an integer from about 5 to about 30, and 1 is the residue of the divalent initiator.

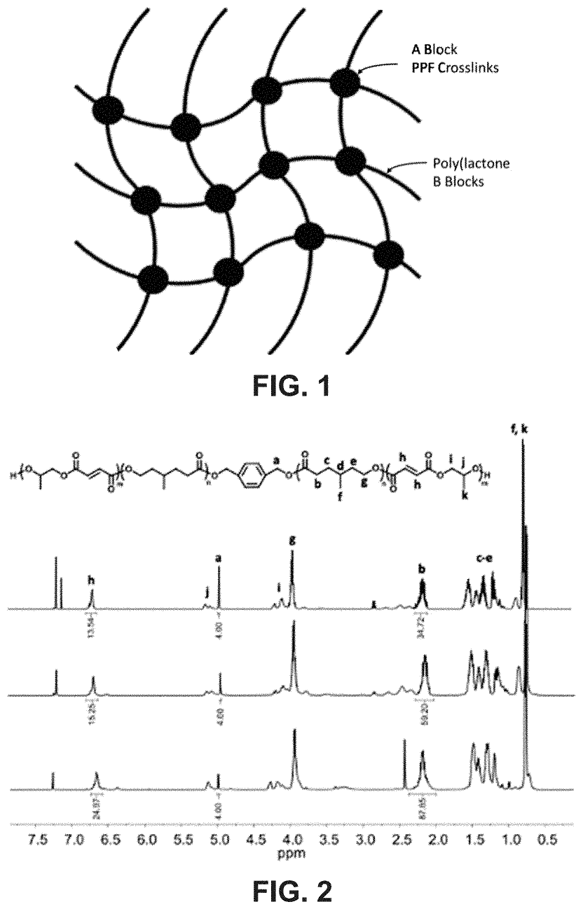

In a third aspect, the present invention is directed to 3D printable resins comprising any one or more of the ABA triblock copolymers described above. In some embodiments, the 3D printable resins of the present invention will comprise a poly(propylene fumarate-b-γ-methyl-ε-caprolactone-b-propylene fumarate) ABA triblock copolymer. As will be apparent, the neat ABA triblock copolymers of the present invention are too viscous to be used in 3D printing and must be diluted to a workable viscosity. To do this, a quantity of a suitable organic solvent, such as diethyl fumarate, ethyl acetate, THF, acetone, DMSO, chloroform, methanol, ethanol, and combinations thereof, is added as a diluent. The preferred diluent, however, is diethyl fumarate (DEF) since it also acts to help to form the crosslinks between the various A block segments. (See FIG. 1).

In one or more embodiments, 3D printable resins will comprise from about 1 wt. % to about 60 wt. % diethyl fumarate. In some embodiments, 3D printable resins will comprise from about 5 wt. % to about 60 wt. %, in other embodiments, from about 10 wt.% to about 60 wt. %, in other embodiments, from about 20 wt. % to about 60 wt. %, in other embodiments, from about 30 wt. % to about 60 wt. %, in other embodiments, from about 40 wt. % to about 60 wt. %, in other embodiments, from about 50 wt. % to about 60 wt. %, in other embodiments, from about 1 wt. % to about 50 wt. %, in other embodiments, from about 1 wt. % to about 40 wt. %, and in other embodiments, from about 1 wt. % to about 30 wt. % diethyl fumarate. In some embodiments, 3D printable resins will comprise from about 50 wt. % diethyl fumarate.

In addition, the 3D printable resins of the present invention will comprise a photoinitiator to facilitate crosslinking during 3D printing. The photoinitiators that may be used in the 3D printable resins of embodiments of the present invention are not particularly limited and may be any photoinitiator capable of producing a radical at a suitable wavelength (approximately 254-450 nm) provided that it is otherwise compatible with the printed 3D structure (including the polymer and any additives) and does not interfere with the crosslinking. As will be appreciated by those of skill in the art, the choice of photoinitiator is often dictated by the requirements of the 3D printer being used, but suitable photoinitiators may include, without limitation, phenylbis(2,4,6-trimethylbenzoyl)phosphine oxide (BAPO), IRGACURE™ 819/BAPO (BASF, Florham Park, N.J.) or IRGACURE™ 784 (BASF, Florham Park, N.J.), IRGACURE™ 2959, or a combination thereof.

Other additives commonly used in 3D printable resins such as dyes, light attenuating agents, dispersants, emulsifiers, ceramics, bioglass, hydroxyapatite, β-tricalcium phosphate, crosslinkers and/or other solvents. The dyes that may be used in the 3-D printable resin of embodiments of the present invention are not particularly limited and may any dye conventionally used in 3D printing, provided that it does not quench the radicals necessary for crosslinking. The light attenuating agents that may be used in the 3-D printable resin of embodiments of the present invention are not particularly limited and may include, without limitation, oxybenzone (2-Hydroxy-4-methoxybenzophenone) (Sigma-Aldrich). The emulsifiers that may be used in the 3-D printable resin of embodiments of the present invention are not particularly limited and may include, without limitation, sucrose, threhalose, or any sugar molecule.

In various embodiments, the 3D printable resin of embodiments of the present invention may include one or more other additives to support and/or promote tissue growth. The additives are not particularly limited provided that they do not quench the radicals needed for crosslinking of the 3-D printable resin. In various embodiments, the 3-D printable resin may contain additives such as, ceramics, BIOGLASS™ hydroxyapatite, β-tricalcium phosphate, and combinations thereof.

In various embodiments, the various resin components described above (e.g. photoinitiators, dyes, light attenuating agents, dispersants, emulsifiers, ceramics, bioglass, hydroxyapatite, β-tricalcium phosphate, crosslinkers and/or solvents) may be added to the 3-D printable resin at any time prior to crosslinking of the PPF polymer, as described below.

In various embodiments, the 3D printable resins of the present invention will have a complex viscosity (η*) of from 0.1 Pa·s to about 15 Pa·s, as measured by using a rheometer. In one or more embodiments, the ABA block copolymers resins of the present invention has a complex viscosity of from about 0.1 Pa·s to about 13 Pa·s, preferably from about 0.1 Pa·s to about 11 Pa·s, and more preferably from about 0.1 Pa·s to about 9 Pa·s. In some embodiments, the ABA block copolymer resins of the present invention will have a complex viscosity (η*) of from 0.1 Pas to about 7 Pa·s, in other embodiments, from about 0.1 Pa·s to about 5 Pa·s, in other embodiments, from about 1 Pa·s to about 15 Pa·s, in other embodiments, from about 3 Pa·s to about 15 Pa·s, in other embodiments, from about 5 Pa·s to about 15 Pa·s, in other embodiments, from about 8 Pa·s to about 15 Pa·s, in other embodiments, from about 10 Pa·s to about 15 Pa·s, in other embodiments, from about 12 Pa·s to about 15 Pa·s, and in other embodiments, from about 3 Pa·s to about 7 Pa·s. (See, FIG. 7). Here, as well as elsewhere in the specification and claims, individual range values can be combined to form additional non-disclosed ranges.

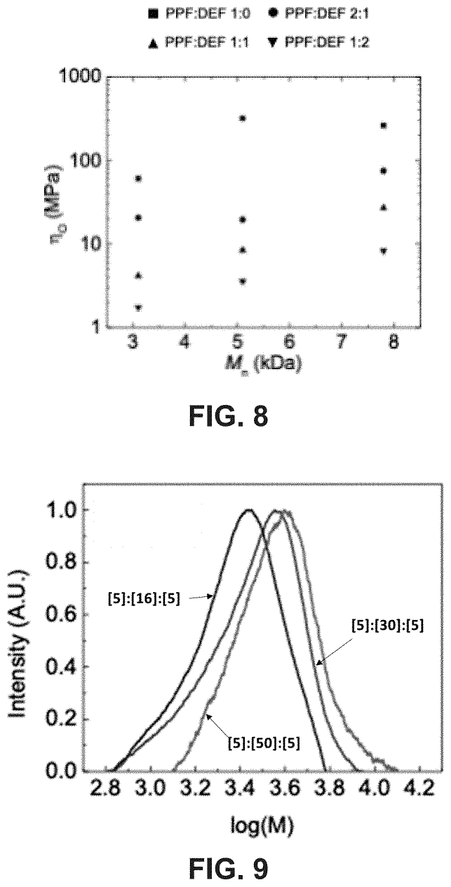

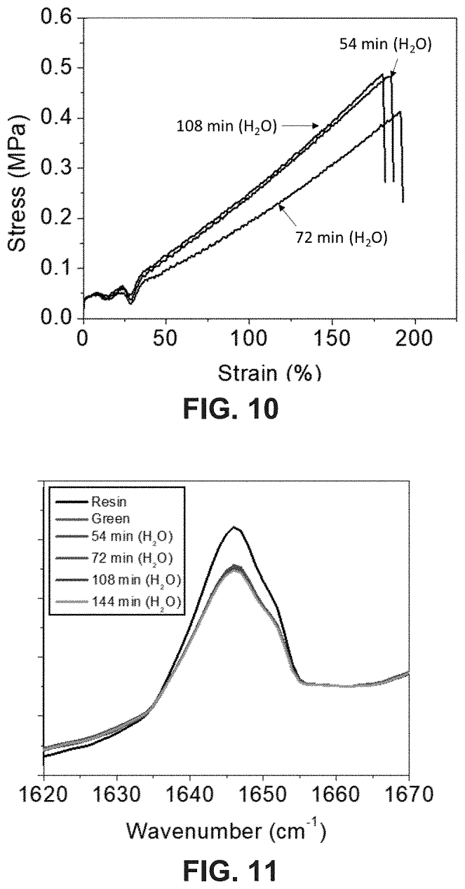

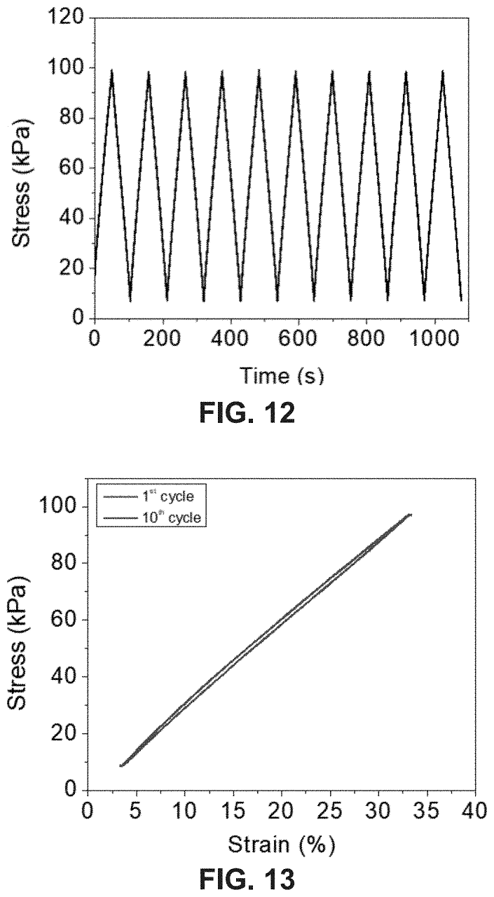

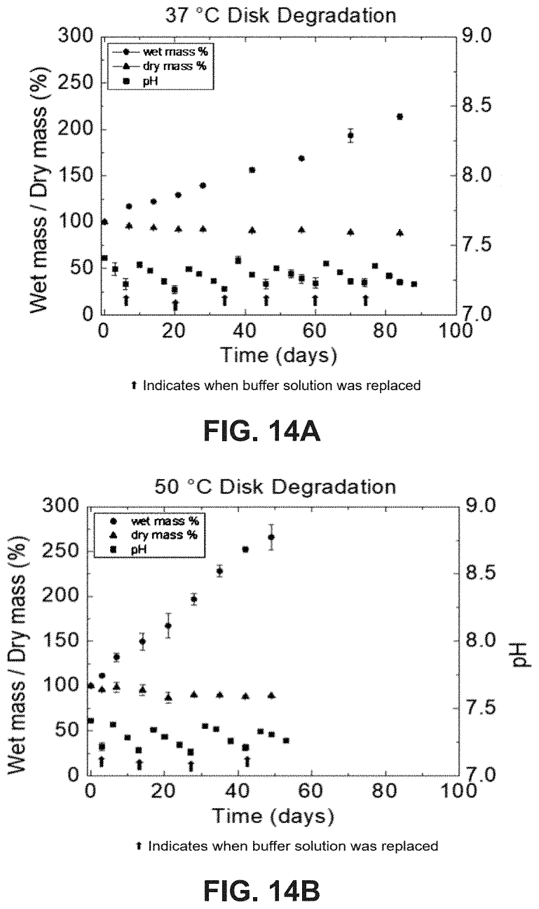

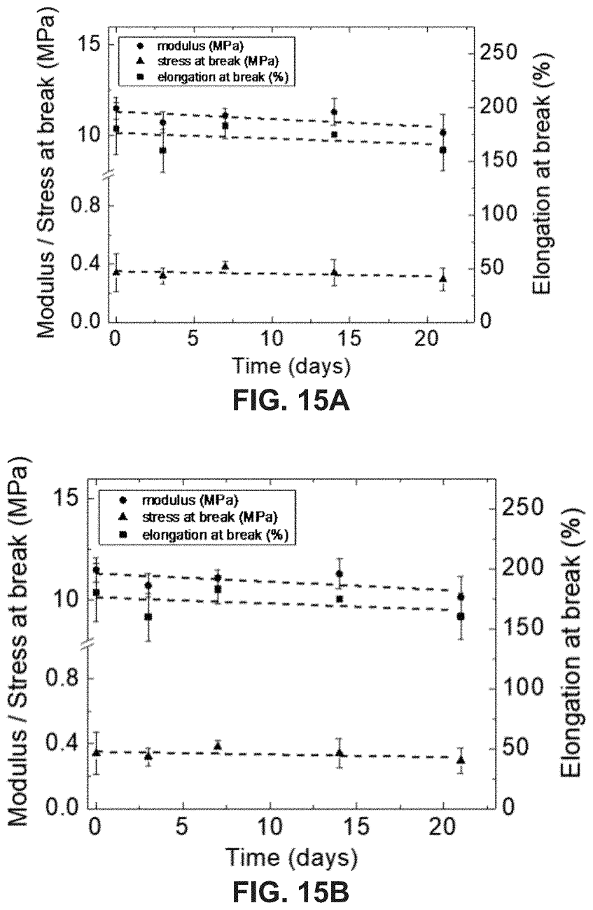

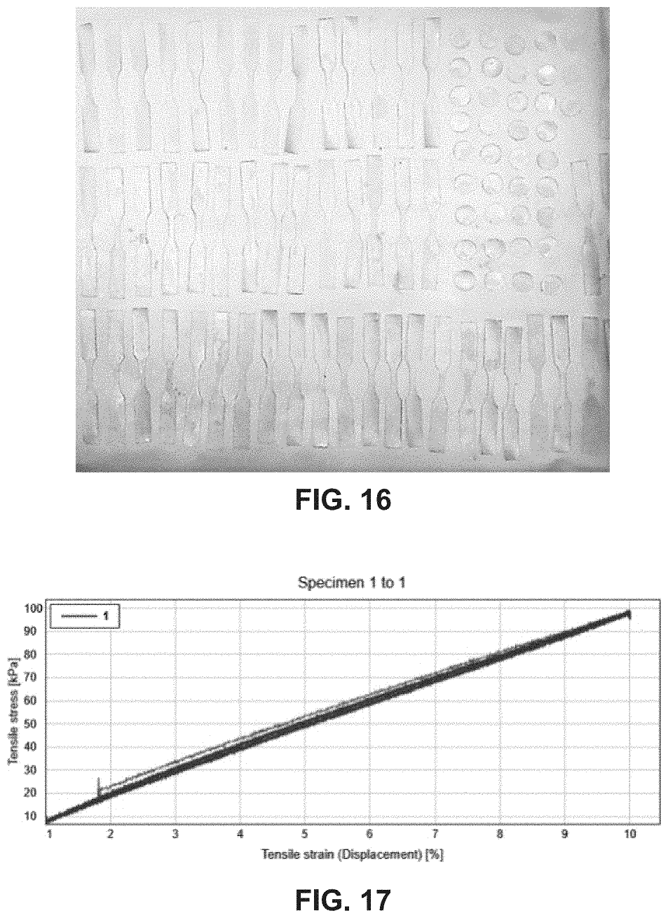

As will be understood by those of skill in the art, the zero-shear viscosity of the ABA block copolymer resins of the present invention may be obtained by extrapolation of complex viscosity vs. angular frequency to zero angular frequency. (See, FIG. 8). In various embodiments, the zero-sheer viscosity (η₀) of the ABA block copolymer resins of the present invention is from 1 Pa·s to about 400 Pa·s, preferably from 1 Pa·s to about 100 Pa·s, and more preferably from 1 Pa·s to about 20 Pa·s. Here, as well as elsewhere in the specification and claims, individual range values can be combined to form additional non-disclosed ranges.

In another aspect, the present invention is directed 3D printed elastomer structures made from the 3D printable resins described above and comprising the ABA triblock copolymers described above. In various embodiments, the present invention produces a photolithographically-printable elastomer comprising one or more of the ABA triblock copolymers discussed above. In one or more embodiments, the photo-crosslinkable 3D printable resins of the present invention can be printed using conventional additive manufacturing (3D printing) techniques, such as stereolithography or continuous digital light processing (cDLP) techniques and photocrosslinked to form 3D printed structures having virtually any shape. Any suitable light-based 3D printer may be used. Suitable 3-D printers may include, without limitation, Carbon3D printers (CARBON3DTM, Redwood City, Calif.), PERFACTORY™ P3 3D printer (EnvisionTEC, Dearborn, Mich.), Micro HR 279 printer EnvisionTEC (Dearborn, Mich., USA), photocentric stereolithographic or photochemical 3D printers. In some embodiments, photo-crosslinkable 3-D printable resins of the present invention be printed using Micro HR 279 (EnvisionTEC, Dearborn, Mich., USA) printer using a 405 nm LED UV light projector with an irradiance of 225 mW dm⁻². In some embodiments, the ABA triblock copolymer resins set forth above may be printed using a Carbon M2 printer (Carbon 3D, Redwood City, Calif.), which uses continuous liquid interface production (CLIP) technology. The printed ABA triblock structures are then washed three times with a 1:1 solution of deionized water and acetone followed by deionized water, and post cured either dry or in deionized water in a UV curing chamber for varied durations of time. In one or more embodiments, the newly printed ABA triblock printed structure may be cured by exposing it to ultraviolet light using a PROCURE™ UV box (3D Systems, Rock Hill, S.C.).

In various embodiments, the ABA triblock printed structure of the present invention may be formed by first generating a set of instructions for 3D printing a desired structure and sending those instructions to a suitable 3D printer. In some of these embodiments, the set of instructions may comprise a computer assisted design (CAD) file generated using suitable computer software that are readable by the 3D printer to be used. In some embodiments, the design files may be created using SolidWorks software (Dassault Systems SolidWorks Corp., Waltham, Mass.). In some embodiments, the CAD models were sliced digitally into layers using the Perfactory software suite prior to manufacturing. The Perfactory P3 is an inverted system that projects upward through a transparent glass plate into a reservoir containing the resin. In one or more embodiments, the CAD or other computer file containing instructions for printing the ABA triblock printed structure may be generated as set forth in U.S. Pat. Nos. 6,849,223, 7,702,380, 7,747,305, 8,781,557, 9,208,558, 9,275,191, 9,292,920, 9,330,206, 9,626,756, 9,672,302, 9,672,617, and 9,688,023, the disclosures of which are incorporated herein by reference in their entirety.

In one or more embodiments, the newly printed ABA triblock polymer structure may be further cured by exposing it to ultraviolet light for a period of from about 1 minute to about 10 hours, preferably from about 1 minute to about 1 hour, and most preferably from about 1 minute to about 5 minutes to photochemically crosslink the newly printed 3D PPF structure. As will be appreciated, the newly printed ABA triblock polymer structure should be cured long enough to permit sufficient crosslinking to provide the necessary rigidity and strength for the desired use but not so long that the UV irradiation damages the polymer. In one or more embodiments, the newly printed ABA triblock polymer structure is cured from about 5 seconds to about 500 seconds. In some embodiments, the newly printed ABA triblock polymer structure is cured from about 5 seconds to about 400 seconds, in other embodiments, from about 5 seconds to about 400 seconds, in other embodiments, from about 5 seconds to about 300 seconds, in other embodiments, from about 5 seconds to about 200 seconds, in other embodiments, from about 30 seconds to about 500 seconds, in other embodiments, from about 60 seconds to about 500 seconds, in other embodiments, from about 120 seconds to about 500 seconds, and in other embodiments, from about 200 seconds to about 500 seconds.

Once the newly printed ABA triblock polymer structure is fully cured, it is then rinsed to remove any uncured resin. In some embodiments the step of rinsing away the uncured resin comprises rinsing the structure with a buffered water miscible solvent solution. Suitable water miscible solvents may include, without limitation, acetone, methanol, or ethanol, or a combination thereof, but is preferably acetone. The water miscible solvents may be buffered with any suitable buffer solution that buffers to a biologically appropriate pH, but are preferably buffered with Phosphate Buffered Saline (PBS). Also, because DEF can be toxic, unreacted, residual DEF must be removed from the cured ABA triblock polymer structure before they can be used in medical applications.

In various embodiments, the 3D printed polymer structures of the present invention will have a strain at break ( ebreak) of from about 150% to about 250%, preferably from about 150% to about 200%, and more preferably from about 150% to about 170%.

In one or more embodiments, the 3D printed polymer structures of the present invention will have a Young's modulus (E₀) of from about 1.6 MPa to about 12.6 MPa, preferably from about 5 MPa to about 12.6 MPa, and more preferably from about 8 MPa to about 12.6 MPa.

In various embodiments, the 3D printed polymer structures of the present invention will have a stress at break (UTS) of from about 0.33 MPa to about 1.27 MPa, preferably from about 0.5 MPa to about 1.27 MPa, and more preferably from about 1.00 MPa to about 1.27 MPa.

### EXPERIMENTAL

To more fully illustrate and reduce the invention to practice, ABA triblock copolymers according to the present invention were synthesized by sequential ROP and ROCOP using Mg(BHT)₂(THF)₂ as a catalyst and γ-methyl-ε-caprolactone (γmεCL) as the lactone monomer, as set forth above, to produce ABA triblock poly(propylene fumarate-b-γmεCL-b-propylene fumarate) copolymers having targeted block ratios of [5]:[16]:[5], [5]:[30]:[5], and [5]:[50]:[5]. To ensure elastomeric contribution of the γmεCL block in the mechanical properties of the 3D-network, it was determined that the triblock copolymer design would contain a middle lactone block surrounded by cross-linkable PPF units. The structure, viscosity, thermal properties, hydrolytic degradation properties and mechanical properties of these polymers and/or crosslinked polymer resins made therefrom were then tested and evaluated, as described below. It is believed that these experiments offer a framework for the facile synthesis of stereolithographically printable elastomers using well-known degradable polyesters.

### Synthesis and Structure

As set forth above, the ABA type triblock copolymers of the present invention are synthesized so that the A blocks contain crosslinkable PPF units and the middle B block contains the softer lactone segment. (See, FIGS. 1, 2) A general reaction scheme for forming ABA type triblock copolymers used for these experiments is shown in Scheme 4 below.

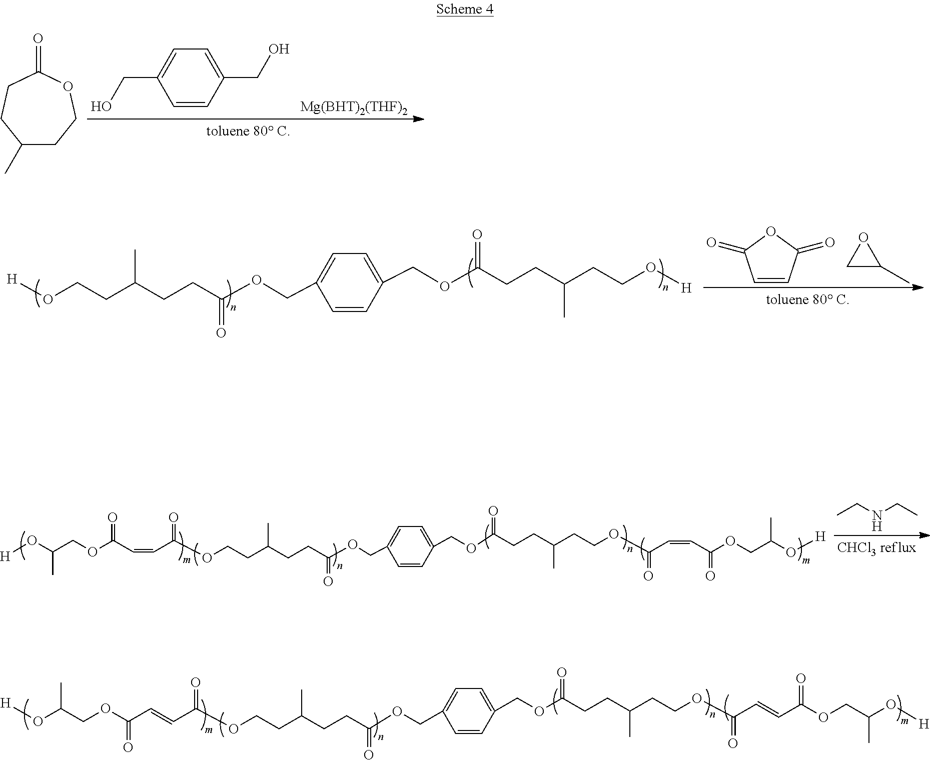

As can be seen, ABA triblock copolymers containing γ-methyl-ε-caprolactone and poly(propylene fumarate) were synthesized in sequential ring opening polymerization reactions followed by an isomerization step. As set forth above, the respective block length ratios can be controlled using stoichiometry as the conversion is high.

The polymerization of poly(propylene maleate-b-γ-methyl-ε-caprolactone-b-propylene maleate) (P(PM-b-γmεCL-b-PM)) intermediate was conducted using 1,4-dimethoxy benzene (BDM) as an initiator and 2 mol % Mg(BHT)₂(THF)₂ as a catalyst. A detailed description of the synthetic procedure can be found above and in Example 2, below. An aliquot of the crude reaction solution was taken prior to precipitation from hexanes in order to determine monomer conversions of ymeCL and MAn using ¹H NMR spectroscopy. Nearly complete conversion of the ymcCL monomer and over 80% conversion of MAn were observed in each polymerization. These results were consistent with previously reported data for similar diblock copolymers. See, e.g., Yeh, Y.-C.; Highley, C. B.; Ouyang, L.; Burdick, J. A., 3D Printing of Photocurable Poly(glycerol sebacate) Elastomers. Biofabrication 2016, 8, 045004, the disclosure of which is incorporated herein by reference in its entirety. ¹H NMR spectroscopic analysis of the recovered material showed proton resonances corresponding to poly(γmεCL), the PPF cis-isomer poly(propylene maleate) (PPM), and BDM. As observed previously similar systems, no resonances corresponding to the methylene protons of homopolymerized PO were observed, indicating the absence of ether linkages. The PPM blocks were isomerized to the fumarate form as set forth above to provide an internal alkene available for printing using Continuous Liquid Interface Production (CLIP). ¹H NMR spectroscopic analysis after isomerization (FIG. 2) showed a complete reduction of the cis-alkene resonance (δ=6.3 ppm) and a new resonance corresponding to the trans-alkene protons (δ=6.7 ppm). Details on the complete synthetic procedure can be found in Example 3, below.

This synthetic procedure was used to create a series of polymers with varied lactone content, the results of which are summarized in Table 1. Both the aromatic and the adjacent methylene protons from the BDM initiator were clearly visible by ¹H NMR spectroscopy. As such, the degree of polymerization (DPₙ) of the recovered polymers were determined using integration ratios of the proton resonances corresponding to γmεCL (δ=2.2 ppm), MAn (δ=6.7 ppm), and BDM (δ=5.0 ppm). The number average molecular mass, weight average molecular mass, and molecular mass distributions (D_{M}) were determined using size-exclusion chromatography (SEC) in CHCl₃ against polystyrene standards. (FIG. 9) SEC analysis showed a single distribution for each polymer with D_{M} values consistent with those previously reported for lactone and PPF block copolymers (D_{M}<1.2). (See, e.g., Petersen, S. R.; Wilson, J. A.; Becker, M. L., Versatile Ring-Opening Copolymerization and Postprinting Functionalization of Lactone and Poly(propylene fumarate) Block Copolymers: Resorbable Building Blocks for Additive Manufacturing. Macromolecules 2018, 51 (16), 6202-6208, the disclosure of which is incorporated herein by reference in its entirety). Block ratios consistent with those targeted and narrow molecular mass distributions indicate near living conditions and control during the polymerization. There has been no evidence of transesterification of during the isomerization process.

TABLE 1
Characterization of poly(PF-b-γmεCL-b-PF) triblock copolymers

| | | γmεCL | MAn | | | | | |
|---|---|---|---|---|---|---|---|---|
| Target | Actual | conv. | conv. | Mₙ | Mₙ | M_{w} | | T_{g} |
| [PF]:[L]:[PF] | [PF]:[L]:[PF]^{a} | (%)^{b} | (%)^{b} | (kPa)^{a} | (kpa)^{c} | (kpa)^{c} | Ð_{M}^{c} | (° C.)^{d} |
| [5]:[16]:[5] | [3]:[17]:[3] | 99 | 83 | 3.1 | 2.2 | 2.6 | 1.20 | −38 |
| [5]:[30]:[5] | [4]:[30]:[4] | 98 | 90 | 5.1 | 2.6 | 3.2 | 1.18 | −52 |
| [5]:[50]:[5] | [6]:[46]:[6] | 95 | 96 | 7.8 | 3.4 | 4.0 | 1.17 | −59 |

^{a}Determined by ¹H NMR spectroscopic analysis of the final reaction product
^{b}Determined by ¹H NMR spectroscopic analysis of the crude reaction solution
^{c}Determined by SEC in CHCl₃ against polystyrene standards
^{d}Determined by differential scanning calorimetry

### Thermal Properties

Differential scanning calorimetry (DSC) was used to investigate the thermal properties of the triblock copolymers. (See FIGS. 3-6) All of the polymers were amorphous with glass transition temperatures (T_{g}) well below room temperature, which is consistent with previously reported data. (See, e.g., Petersen, S. R.; Wilson, J. A.; Becker, M. L., Versatile Ring-Opening Copolymerization and Postprinting Functionalization of Lactone and Poly(propylene fumarate) Block Copolymers: Resorbable Building Blocks for Additive Manufacturing. Macromolecules 2018, 51 (16), 6202-6208, the disclosure of which is incorporated herein by reference in its entirety). The polymer with the smallest γmεCL content exhibited the highest T_{g}, which decreased as the degree of polymerization (DPₙ) of the lactone block increased.

### Viscosity

Viscosity requirements in stereolithographic techniques prevent PPF from being printed neat, thus diethyl fumarate (DEF) is often added as a reactive diluent in order to reduce the viscosity. In order to investigate how the introduction of the γmεCL block affected the rheological properties of the polymer, the complex viscosity (η*) of each of the polymers was investigated with varied PPF:DEF ratios. (See, FIG. 7). Zero-shear viscosity values were obtained by extrapolation of complex viscosity vs. angular frequency to zero angular frequency. (See, FIG. 8). The viscosity of each material decreased as the fraction of DEF in the resin increased. Although the T_{g} of the triblock copolymers decreased as the size of the lactone block increased, the complex viscosity increased. This suggests that the viscosity of the materials is primarily influenced by the molecular mass of the polymer rather than the block ratio.

The zero-shear viscosities of both [5]:[16]:[5] (6.1 Pa·s) and [5]:[30]:[5] (8.9 Pa·s) polymers were low enough to afford printing at a 1:1 wt. ratio in DEF and each polymer resin was prepared at a 1:1 PPF:DEF wt. ratio with a previously reported mixture of photoinitiators. (See, e.g., Luo, Y.; Dolder, C. K.; Walker, J. M.; Mishra, R.; Dean, D.; Becker, M. L., Synthesis and Biological Evaluation of Well-Defined Poly(propylene fumarate) Oligomers and Their Use in 3D Printed Scaffold. Biomacromolecules 2016, 17, 690-697 and Petersen, S. R.; Wilson, J. A.; Becker, M. L., Versatile Ring-Opening Copolymerization and Postprinting Functionalization of Lactone and Poly(propylene fumarate) Block Copolymers: Resorbable Building Blocks for Additive Manufacturing. Macromolecules 2018, 51 (16), 6202-6208, the disclosures of which are incorporated herein by reference in their entirety). (See also, FIG. 8). As the [5]:[50]:[5] polymer was too viscous to print with a 1:1 PPF:DEF ratio (72.3 Pa·s),the resin was prepared at a 1:2 wt. ratio of PPF:DEF containing identical photoinitiator content. The [5]:[16]:[5] and [5]:[30]:[5] resins were printed on a Carbon M2 printer (Carbon 3D, Redwood City, Calif.), which uses CLIP technology. After washing the printed objects three times with a 1:1 solution of deionized water and acetone followed by deionized water, the tensile bars printed from the [5]:[16]:[5] and [5]:[30]:[5] resins were post cured either dry or in deionized water in a UV curing chamber for varied durations of time. Printing of the [5]:[50]:[5] resin was attempted on a Carbon M2 printer. Although some crosslinking of the resin was observed, a defined structure could not be formed during printing. As this polymer had the largest lactone block between crosslinkable units and the resin required a higher proportion of reactive diluent, it is suspected that the print failure occurred to insufficient cross-link density.

### Mechanical Properties of the 3D Printed (Photocrosslinked) Resins

Mechanical analysis of the materials was conducted by placing the 3D printed tensile bars under uniaxial extension until failure. (See. FIG. 10) Unexpectedly, the mechanical properties of the tensile bars printed with the [5]:[16]:[5] resin did not trend with the post cure time. In order to investigate this phenomenon, Fourier transform infrared spectroscopy (FTIR) was used to monitor alkene consumption at various post-cure times. (See, FIG. 11). A notable decrease in peak intensity of the C═C stretching (1625-1665 cm⁻¹) region was observed after printing the material. However, the intensity of the C═C stretching peak remained constant after printing, regardless of the post-cure time. (See. FIG. 10). On the other hand, an increase in the modulus (E₀) (MPa), strain at break (ε_{break}) (%), and stress at break (UTS) (MPa) of the tensile bars printed with the [5]:[30]:[5] resin was observed when they were post-cured for up to 72 minutes. Post-curing for more than 72 minutes resulted in a slight decrease in these properties.

The tensile data obtained from the [5]:[16]:[5] and [5]:[30]:[5] polymers also suggest that the block ratio of the triblock copolymers influences the ultimate mechanical performance. When post-cured for the optimal time to maximize mechanical performance, the [5]:[30]:[5] had a slightly higher stress (UTS=1.27 MPa) and strain at break (ε_{break}=251.6) than any [5]:[16]:[5] sample. Additionally, the moduli of the [5]:[16]:[5] materials were consistently an order of magnitude larger than those observed in the [5]:[30]:[5] materials. This result is valid, as the polymer with the smaller lactone block contains a larger proportion of hard, crosslinked domains to increase the stiffness of the materials. The results of these studies are summarized in Table 2. In order to understand the elastic response of the triblock copolymers, the printed [5]:[16]:[5] material was exposed to cyclic deformation to 20% of the maximum strain at break. (See. FIGS. 12; see also FIG. 17) The material exhibited nearly perfect elastic recovery, with minimal energy loss observed with repeated deformation. (See. FIG. 13).

TABLE 2
Mechanical characterization of poly(PF-b-γmεCL-b-PF)
triblock copolymers with [5]:[16]:[5] and [5]:[30]:[5] block ratios.

| Polymer | Post cure (min) | | Eₒ (MPa) | ϵ_{break} (%) | UTS (MPa) |
|---|---|---|---|---|---|
| [5]:[16]:[5] | 54 | (H₂O) | 12.6 ± 0.32 | 193 ± 9.4 | 0.46 ± 0.11 |
| | 72 | (H₂O) | 11.5 ± 0.61 | 180 ± 24.2 | 0.34 ± 0.13 |
| | 108 | (H₂O) | 12.0 ± 0.80 | 164 ± 23.0 | 0.37 ± 0.12 |
| | 144 | (H₂O) | 12.5 ± 1.11 | 155 ± 57.1 | 0.39 ± 0.14 |
| [5]:[30]:[5] | 0 | | 1.6 ± 0.13 | 164.0 ± 13.7 | 0.33 ± 0.04 |
| | 72 | | 1.6 ± 0.02 | 166.6 ± 45.1 | 0.50 ± 0.22 |
| | 72 | (H₂O) | 2.0 ± 0.14 | 251.6 ± 28.0 | 1.27 ± 0.12 |
| | 144 | (H₂O) | 1.8 ± 0.05 | 211 ± 20.3 | 0.71 ± 0.01 |

### Hydrolytic Degradation

Tensile bars and discs printed from the [5]:[16]:[5] polymer resin (post-cured 54 min in H₂O) were used in an in vitro degradation study to examine the material response to hydrolytic degradation. (See, FIGS. 14A-B, 15A-B, 16) First, water uptake and polymer degradation were investigated by submerging printed discs in sodium phosphate buffer solution (PBS) (pH=7.4) at 37° C. and 50° C. Discs in both groups swelled notably, with the wet mass of the discs increasing to over 200% at both temperatures over the course of the study. (See. FIG. 14A) However, discs submerged in the 50° C. environment had faster water uptake, with the wet mass increasing to just over 250% in 42 d. For comparison, the wet mass of the discs incubated at 37° C. increased to just over 150% in the same amount of time. The increased rate of water absorption at 50° C. resulted in a faster rate of hydrolytic degradation in the discs. After 42 d, the discs degraded at 50° C. had lost 11.8% of their mass. Alternatively, it took 84 d for the discs degraded at 37° C. to lose an average of 11.7% of their mass. Extrapolation of the mass loss as a function of time suggests that 50% mass loss will occur in 424 d at 37° C. and 209 d at 50° C. The results of this study are summarized in FIGS. 14A-B. At 50° C., the pH of the buffer solution also decreased more rapidly, particularly in the early stages of the experiment. As a decrease in the pH of the solution corresponds to increased presence of the acidic degradation products of the polymer, the increased magnitude of the pH drop at the higher temperature confirms the faster polymer degradation rate.

To understand how the degradation affects the mechanical properties, tensile bars printed from the [5]:[16]:[5] polymer resin were also submerged in PBS buffer solution (pH=7.4) at 37° C. During the study the tensile bars swelled at a similar rate to the discs at 37° C., with the average wet mass increasing to 127% throughout the duration of the study. Mechanical analysis was performed by uniaxial extension of the swollen samples until failure. Interestingly, the mechanical properties of the tensile bars showed little change throughout the duration of the experiment. Although this result is not entirely unexpected considering the relatively small mass loss during this time frame, it is notable because premature mechanical failure upon degradation is commonly observed in degradable elastomers, particularly those with physically crosslinked networks. The results of this experiment are summarized in Table 3 and FIGS. 15A-B.

TABLE 3
Mechanical characterization of poly(PF-b-γmεCL-b-
PF) triblock copolymers with a [5]:[16]:[5]
block ratio upon hydrolytic degradation in PBS buffer solution

| Time (d) | Eₒ (MPa) | ϵ_{break} (%) | UTS (MPa) | Wet mass |
|---|---|---|---|---|
| 0 | 11.5 ± 0.6 | 180.0 ± 24.0 | 0.34 ± 0.13 | 100.0 ± 0.0 |
| 3 | 10.7 ± 0.6 | 159.6 ± 20.0 | 0.32 ± 0.06 | 107.3 ± 0.6 |
| 7 | 11.1 ± 0.4 | 182.5 ± 12.0 | 0.38 ± 0.04 | 112.6 ± 1.0 |
| 14 | 11.3 ± 0.7 | 174.7 ± 0.3 | 0.34 ± 0.09 | 116.1 ± 4.1 |
| 21 | 10.1 ± 1.0 | 160.2 ± 18.9 | 0.30 ± 0.08 | 127.3 ± 0.6 |

The utility of additive manufacturing in tissue engineering and regenerative medicine will be dependent on the availability of resorbable materials that can be printed. Herein, we demonstrated the synthesis of a series of ABA triblock poly(propylene fumarate-b-γ-methyl-ε-caprolactone-b-propylene fumarate) copolymers through sequential ROP and ROCOP using Mg(BHT)₂(THF)₂ as a catalyst. Two of these polymers with varying ratios of lactone block are the first report of a degradable printable elastomer using a continuous liquid interface production Carbon DLP M2 printer. The printed materials were shown to be durable elastomers that maintain their mechanical performance during slow, hydrolytic degradation in vitro. As these materials rely on a combination of well-known resorbable building blocks, this work offers a facile template for the synthesis of photochemically printable elastomers for implantable devices.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Materials

All reagents were purchased from Sigma-Aldrich, with the exception of 2,6-di-tert-4-methylphenol, which was purchased from Acros. All solvents were purchased from Fisher and dried using an Innovative Technology Inc. Pure Solv MD-3 solvent purification system. Benzyl alcohol and propylene oxide were dried over calcium hydride overnight prior to vacuum distillation and stored in an inert atmosphere. Maleic anhydride was sublimated and then dried in vacuo over P₂O₅ for 5 d. 1,4-dimethoxy benzene was dried in a desiccator over P₂O₅ for 5 d prior to use. All other reagents were used as received.

### Example 1

### Synthesis of γ-methyl-ε-caprolactone

A single neck round bottom flask containing 250 mL methylene chloride was cooled in an ice bath prior to addition of 172.57 g (1.0 mol, 1.1 eq.) of m-chloroperoxybenzoic acid. Next, 102.00 g of 4-methylcyclohexanone (0.9 mol, 1.0 eq.) were added dropwise while stirring. After reacting for 16 h, the reaction mixture was cooled in an ice bath and filtered over Celite, then washed thrice with 10% Na₂S₂O₃ solution, brine, and deionized water (3× each). The organic layer was then dried with MgSO₄ and filtered prior to removal of solvent via rotary evaporation. The final product was dried over calcium hydride overnight and distilled under vacuum prior to use. ¹H NMR (500 MHz, 303 K, CDCl₃): δ4.23 (m, 2H), 2.75 (m, 2H), 1.73 (m, 2H), 1.40 (m, 2H), 0.96 (m, 2H). Yield: 58%.

### Example 2

### Representative Synthesis of poly(PM-b-γmεCL-b-PM) Copolymers

A ring-opening polymerization (ROP) of γ-methyl-ε-caprolactone was set up by mixing ymeCL with BDM and Mg(BHT)₂(THF)₂ at a 7 M concentration in dry toluene. The reaction was heated to 80° C. and allowed to continue for 24 h at ambient pressure under a N₂ atmosphere. After the ROP homopolymerization was completed, the reaction was cooled to room temperature prior to addition of propylene oxide (PO), maleic anhydride (MAη), and toluene to maintain the reaction concentration at 7 M. After the reagent injection, the reaction was heated back to 80° C. and stirred under N₂, beginning the alternating ring-opening copolymerization of MAη and PO. After 4 days, the reaction was terminated and the polymer was recovered by precipitation into hexanes.

[5]:[16]:[5]: ¹H NMR (500 MHz, CDCl₃) δ7.28 (s, 2H), 7.20 (s, 1H), 6.94 -6.68 (m, 8H), 5.22 (d, J =3.2 Hz, 2H), 5.10 (d, J=64.0 Hz, 5H), 4.21 (dt, J=15.4, 10.3 Hz, 10H), 4.09-3.81 (m, 23H), 2.91 (d, J=7.3 Hz, 2H), 2.54 (s, 5H), 2.37-2.12 (m, 22H), 1.69-1.29 (m, 55H), 1.29-1.09 (m, 20H), 1.09-0.84 (m, 38H), 0.84-0.82 (m, 2H), −0.00 (d, J=3.7 Hz, 3H). Mₙ=3.1 kDa, D_{M}=1.20. T_{g}=−37.4° C. Yield=81%

[5]:[30]:[5]: ¹H NMR (500 MHz, CDCl₃) δ7.29 (s, 2H), 6.80 (d, J=14.8 Hz, 6H), 5.23 (s, 1H), 5.17 (s, 2H), 5.04 (s, 2H), 4.31 (s, 1H), 4.31-4.16 (m, 6H), 4.12 (s, 2H), 4.10-3.39 (m, 28H), 3.65-3.39 (m, 1H), 3.05-2.41 (m, 13H), 2.36-2.11 (m, 22H), 2.11-1.24 (m, 67H), 1.24-1.09 (m, 9H), 1.09-0.78 (m, 46H). Mₙ=5.1 kDa, D_{M}=1.18. T_{g}=−51.9° C. Yield=85%.

[5]:[50]:[5]: ¹H NMR (500 MHz, CDCl₃) δ7.28 (d, J=2.6 Hz, 1H), 5.03 (s, 1H), 5.01-3.63 (m, 28H), 2.55 (d, J=4.8 Hz, 6H), 2.37- 2.13 (m, 21H), 1.73-1.30 (m, 53H), 1.29-1.15 (m, 8H), 1.11-0.79 (m, 40H). Mₙ=7.8 kDa, D_{M}=1.17. T_{g}=−58.7° C. Yield

### Example 3

### Isomerization of poly(PM-b-γmεCL-b-PM) Copolymers

The recovered polymer was dissolved in chloroform, at a 2 M concentration, and diethylamine (0.3 mol equivalents per alkene) was added. The reaction was heated to 70° C. and allowed to reflux overnight. After completion of the reaction, diethylamine was removed from the polymer by washing with 0.5 M sodium phosphate buffer solution (3×) and solvent was removed under vacuum

### Example 4

### Rheology

In order to determine the appropriate resin formulation, the complex viscosity (η*) of each of the triblock copolymers was investigated using a Discovery Series Hybrid Rheometer with 20 mm parallel plate geometry and a 500 μm gap. As diethyl fumarate (DEF) is used as a reactive diluent when printing poly (propylene fumarate), rheological analysis was done on pure polymer samples, and samples with varied PPF:DEF ratios. The amount of DEF added to each sample was proportional to number of alkenes present, as determined by ¹H NMR spectroscopic analysis. Experiments were performed at a frequency range of 0.1 to 500.0 rad/s at 25° C. with 10% strain. Each sample was heated to 50° C. and mixed vigorously prior to analysis to ensure uniformity. No evidence of crosslinking was observed during this process. Amplitude sweeps were conduction prior to experimentation to ensure that the strain used was within the linear response regime. The results are reported in FIGS. 7, 8.

### Example 5

### Mechanical Testing

Mechanical testing was performed on an Instron 5965 Universal Testing System. Ultimate tensile strength, maximum strain, and Young's modulus were determined by exposing samples to uniaxial deformation at a rate of 500 mm/min until failure. 3D printed samples were pre-strained to 0.01 N of force prior to the start of the test. The Young's modulus was calculated by taking the slope of the stress-strain curve in the linear elastic regime between 0% and 3% strain. All values reported are an average of three samples with the standard deviation reported as the error. Cyclic testing was performed between 3% strain and 34% strain (20% of the average strain at break) at a rate of 10 mm/min for 10 cycles. All mechanical testing was performed at ambient temperature (22° C.). The results are reported in Table 2, and shown in FIGS. 10-13, 17.

### Example 6

### Degradation Study

Round discs (0.6 mm thickness and 12.5 mm diameter) (See, FIG. 16) were used to investigate water uptake and mass loss. For this experiment, discs were submerged in a phosphate buffer saline (PBS) solution (pH=7.4). The PBS solution was replaced whenever the pH dropped below 7.2. Each group in this study included 27 samples for nine time points in triplicate. The first group was incubated at 37° C. while shaking, and the second group was put in a 50° C. oven without shaking. After the wet mass of each sample was reported, the discs were dried in a vacuum oven for 48 h and then weighed to obtain the dry mass. The results are reported in FIGS. 14A-B.

Printed tensile bars (ASTM-Type V-Dogbone, 0.6 mm thick) were used to investigate mechanical performance during hydrolytic degradation. (See, FIG. 16) Samples were submerged in a phosphate buffer saline (PBS) solution (pH=7.4) which was replaced when the pH dropped below 7.2. Fifteen tensile bars were used in each resin formulation, for five time points in triplicate. Samples were patted dry prior to mechanical testing by uniaxial extension until failure at 22° C. The results are reported in Table 3 and shown in FIGS. 15A-B.

In light of the foregoing, it should be appreciated that the present invention significantly advances the art by providing an ABA triblock copolymer that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. An ABA triblock copolymer comprising:
a first and second A polymer block comprising poly(propylene fumarate); and
a B polymer block comprising two poly(lactone) chains extending outward from the residue of a divalent initiator,
wherein said first and second A polymer blocks are each bonded covalently to an end of said B polymer block to form an ABA block copolymer.

2. The ABA triblock copolymer of claim 1 wherein said poly(lactone) chains comprise residues of two or more lactone monomers selected from the group consisting of α-chloro-ε-caprolactone, 4-chloro-ε-caprolactone, 4-methyl-7-isopropyl-ε-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-decalactone macrolactones, ω-pentadecalactone (PDL), functional lactones, θ-propargyl-ε-nonalactone (θpεNL), α-propargyl-ε-caprolactone (αpεCL), and combinations thereof

3. The ABA triblock copolymer of claim 1 wherein said B polymer block comprises γ-methyl-ε-caprolactone.

4. The ABA triblock copolymer of claim 1 wherein said divalent initiator is selected from the group consisting of fumaric acid (FmA), succinic acid, 1,4-cyclohexanedicarboxylic acid (CHDA), 1,4-dimethoxy cyclohexane (CHDM), 1,4-dimethoxy benzene (BDM), cis-but-2-ene-1,4-diol ((Z)-but-2-ene-1,4-diol) (cBD), but-2-yne-1,4-diol (BYD), 1,4-butanediol, 1,5-pentanediol, 1,6-hexanediol (HDO), 1,8-octanediol, 1,10-decanediol (DD), 1,12-dodecandiol, and combinations thereof.

5. The ABA triblock copolymer of claim 1 having the formula: 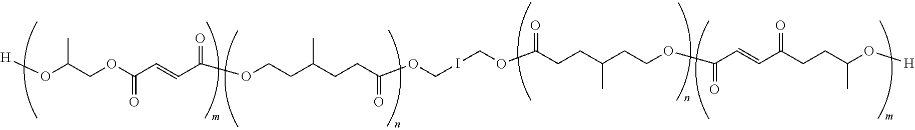
where each n is an integer from about 5 to about 25, each m is an integer from about 5 to about 30, and I is the residue of said divalent initiator.

6. The ABA triblock copolymer of claim 1 having the formula: 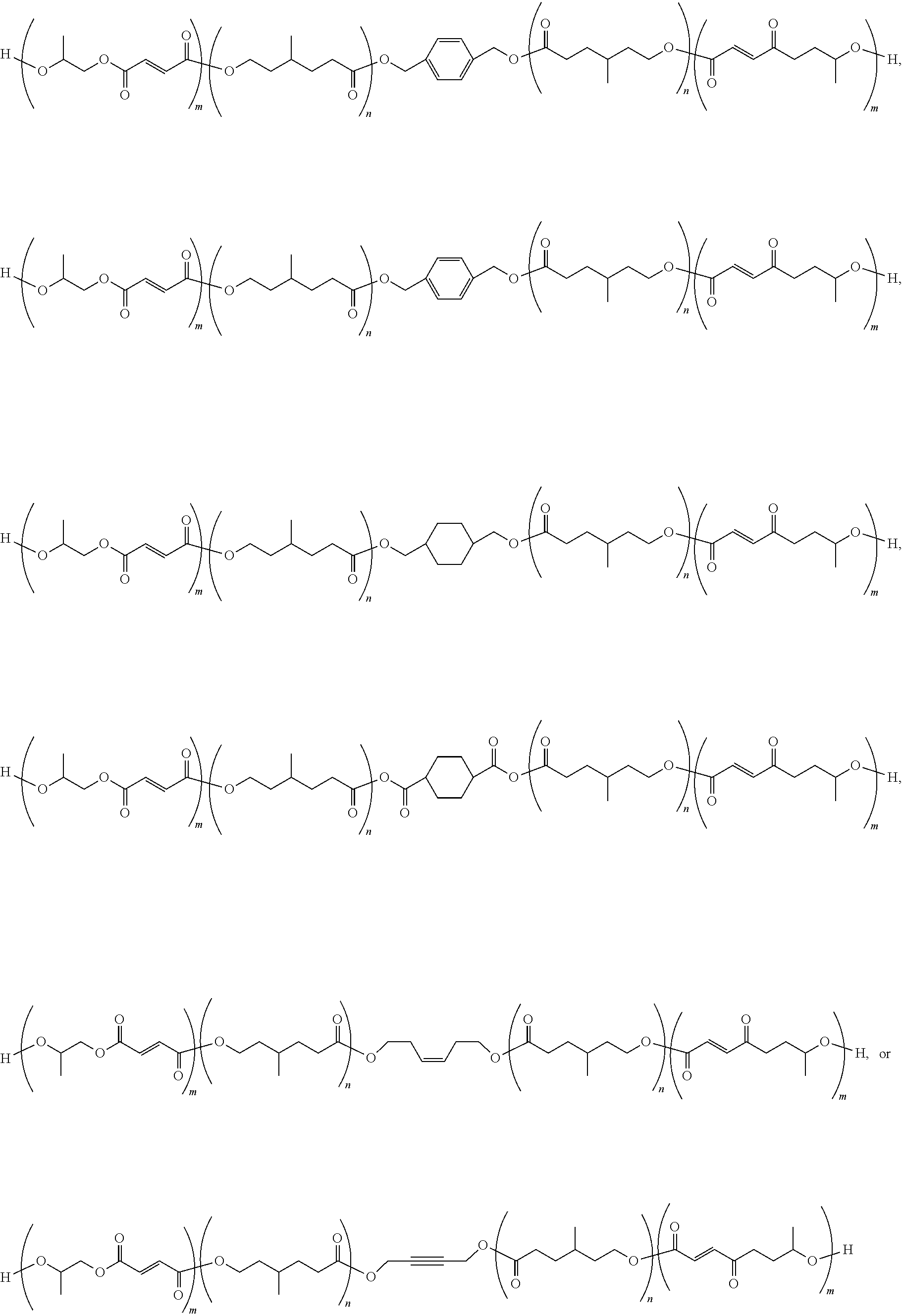
where each n is an integer from about 5 to about 25 and each m is an integer from about 5 to about 30.

7. The ABA triblock copolymer of claim 1 having the formula: 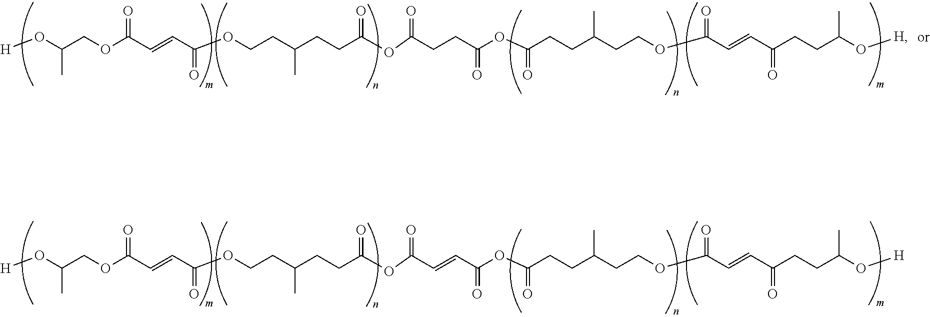
where each n is an integer from about 5 to about 25 and each m is an integer from about 5 to about 30.

8. The ABA triblock copolymer of claim 1 having the formula: 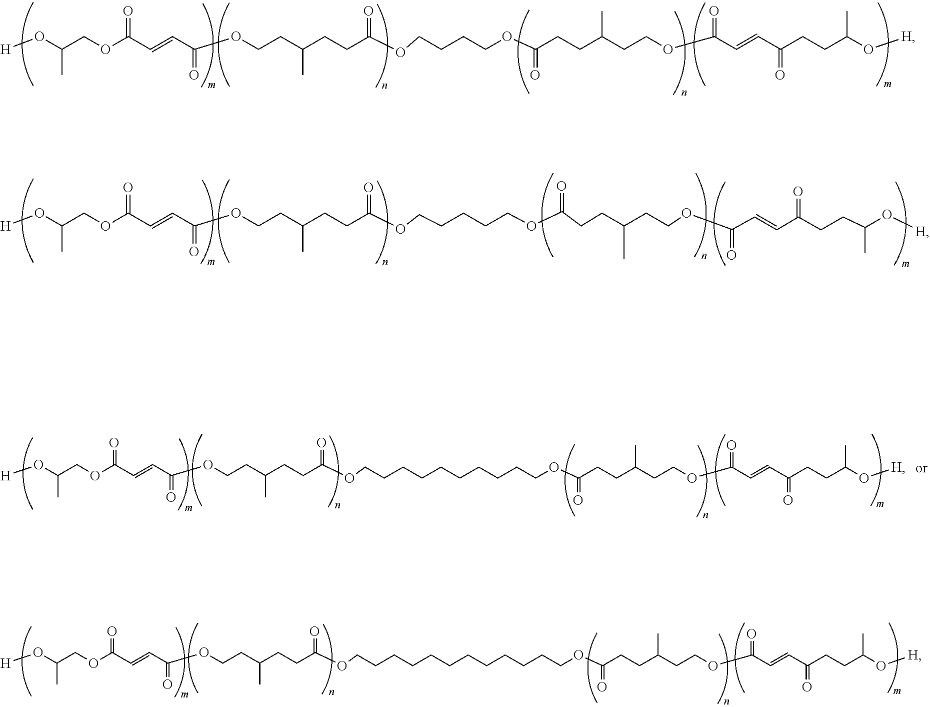
where each n is an integer from about 5 to about 25 and each m is an integer from about 5 to about 30.

9. The ABA triblock copolymer of claim 1 having the formula: 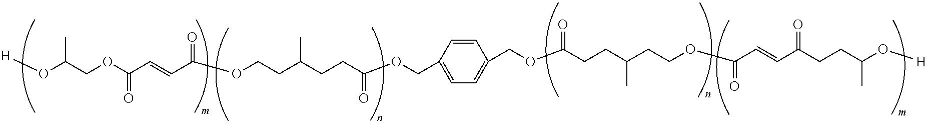
where each n is an integer from about 5 to about 25 and each m is an integer from about 5 to about 30.

10. The ABA triblock copolymer of claim 1 wherein said B polymer block has a degree of polymerization of from about 5 to about 25.

11. The ABA triblock copolymer of claim 10 wherein said A polymer block has a degree of polymerization of from about 5 to about 30.

12. The ABA triblock copolymer of claim 11 wherein the ratio of the degree of polymerization (DPₙ) of said first A polymer block to the total DPₙ said B polymer block to the DPₙ of said second A polymer block is from 5:10:5 to 5:50:5.

13. The ABA triblock co-polymer of claim 12 wherein the ratio of the degree of polymerization (DPₙ) of said first A polymer block to the total (DPₙ) of said B polymer block to the (DPₙ) of said second A polymer block is about 5:10:5 or about 5:20:5.

14. The ABA triblock copolymer of claim 1 having from about 1 mol % to about 50 mol % fumarate units.

15. The ABA triblock copolymer of claims 1 wherein said ABA triblock copolymer is degradable within the body of a patient.

16. A method for making an ABA triblock copolymer comprising:
a. reacting a lactone monomer, a divalent initiator having at least two reactive hydroxyl or carboxylic acid groups, and a catalyst to form a poly(lactone) B block polymer segment having a first and second end, said first and second ends having a reactive hydroxyl or carboxylic acid group;
b. reacting said poly(lactone) B block polymer segment with maleic anhydride, propylene oxide, and a catalyst to form a first poly(propylene maleate) polymer A block covalently bonded to and extending outward from said first end of said poly(lactone) B block polymer segment and a second poly(propylene maleate) polymer A block covalently bonded to and extending outward from said second end of said poly(lactone) B block polymer segment to form an ABA triblock copolymer intermediate having two poly(propylene maleate) A blocks and a poly(lactone) B block; and
c. isomerizing said ABA triblock copolymer intermediate to form an ABA triblock copolymer having two crosslinkable poly(propylene fumarate) A blocks and a poly(lactone) B block.

17. The method of claim 16 wherein said lactone monomer is selected from the group consisting of selected from the group consisting of α-chloro-ε-caprolactone, 4-chloro-ε-caprolactone, 4-methyl-7-isopropyl-ε-caprolactone (menthide), 2,5-oxepanedione (OPD), 7-methyl-4-(1-methylethenyl)-2-oxepanone (dihydrocarvide), 7-(prop-2-ynyl)oxepan-2-one, alkyl-substituted lactones, γ-methyl-ε-caprolactone, ε-decalactone macrolactones, ω-pentadecalactone (PDL), functional lactones, O-propargyl-ε-nonalactone (θpεNL), α-propargyl-ε-caprolactone (αpεCL), and combinations thereof.

18. The method of claim 16 wherein said lactone monomer is γ-methyl-ε-caprolactone.

19. The method of claim 16 wherein the divalent initiator has two reactive hydroxyl or carboxylic acid groups.

20. The method of claim 16 wherein said divalent initiator is selected from the group consisting of fumaric acid (FmA), succinic acid, 1,4-cyclohexanedicarboxylic acid (CHDA), 1,4-dimethoxy cyclohexane (CHDM), 1,4-dimethoxy benzene (BDM), cis-but-2-ene-1,4-diol ((Z)-but-2-ene-1,4-diol) (cBD), but-2-yne-1,4-diol (BYD), 1,4-butanediol, 1,5-pentanediol, 1,6-hexanediol (HDO), 1,8-octanediol, 1,10-decanediol (DD), 1,12-dodecandiol, and combinations thereof.

21. The method of claim 16 wherein said poly(lactone) B block polymer segment formed in Step A has a total degree of polymerization (DPₙ) of from about 5 to about 50.

22. The method of claim 16 wherein said each one of said first and second poly(propylene maleate) polymer A blocks in step B have a degree of polymerization (DPₙ) of from about 5 to about 30.

23. The method of claim 16 wherein the ratio of the degree of polymerization (DPₙ) of said first poly(propylene maleate) poly mer A block to the total DPₙ of said poly(lactone) B block polymer segment to the DPₙ of said second poly(propylene maleate) polymer A block in step B is from 5:10:5 to 5:50:5.

24. The method of claim 16 wherein said ABA block copolymer intermediate is a poly(propylene maleate-b-γ-methyl-ε-caprolactone-b-propylene maleate) ABA block copolymer intermediate having the formula: 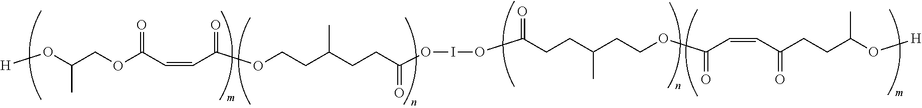
where each n is an integer from about 5 to about 25, each m is an integer from about 5 to about 30, and I is the residue of said divalent initiator.

25. The method of claim 16 wherein said ABA block copolymer is a poly(propylene fumarate-b-γ-methyl-ε-caprolactone-b-propylene fumarate) ABA block copolymer having the formula: 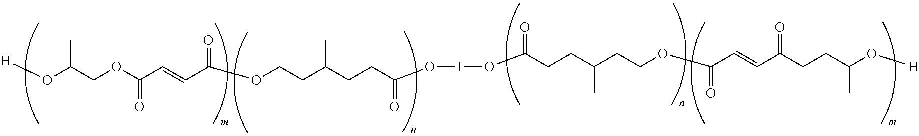
where each n is an integer from about 5 to about 25, each m is an integer from about 5 to about 30, and I is the residue of said divalent.

26. The method of claim 16 wherein said catalyst is Mg(BHT)₂(THF)₂.

27. A 3D printable polymer resin comprising the ABA triblock copolymer of claim 1.

28. The 3D printable polymer resin of claim 27 comprising a poly(propylene fumarate-b-γ-methyl-ε-caprolactone-b-propylene fumarate) ABA triblock copolymer.

29. The 3D printable polymer resin of claim 27 further comprising:
an organic solvent selected from the group consisting of ethyl acetate, THF, acetone, DMSO, chloroform, methanol, ethanol, diethyl fumarate and combinations thereof; and
a photoinitiator.

30. The 3D printable polymer resin of claim 29 comprising from about 1 wt. % to about 60 wt. % diethyl fumarate.

31. The 3D printable polymer resin of claim 29 having a complex viscosity of from about 0.1 Pa·s to about 15 Pa·s.

32. The 3D printable polymer resin of claim 29 having a zero sheer viscosity of from about 1 to about 100.

33. A photolithographically-printable elastomer comprising the ABA triblock copolymer claim 1.

34. A 3D printed polymer structure comprising a covalently crosslinked elastic network formed by photochemically crosslinking the 3D printable polymer resin of claim 29.

35. The 3D printed polymer structure of claim 34 wherein said 3D printed polymer structure has a strain at break (ε_{break}) of from about from about 150% to about 250%.

36. The 3D printed polymer structure of claim 34 wherein said 3D printed polymer structure has a Young's modulus (E0) of from about 1.6 MPa to about 12.5 MPa.

37. The 3D printed polymer structure of claim 34 wherein said 3D printed polymer structure has a stress at break (UTS) of from about 0.33 MPa to about 1.27 MPa.
